(19) United States
(12) Patent Application Publication
(10) Pub. No.: US 2025/0334872 A1
(43) Pub. Date: Oct. 30, 2025

(54) IMAGING OPTICAL SYSTEM, PROJECTION TYPE DISPLAY DEVICE, AND IMAGING APPARATUS

(71) Applicant: FUJIFILM Corporation, Tokyo (JP)

(72) Inventors: Taku FURUBAYASHI, Saitama (JP); Ukyo TOMIOKA, Saitama (JP); Akiko NAGAHARA, Saitama (JP); Masaru AMANO, Saitama (JP); Takashi KUNUGISE, Saitama (JP)

(73) Assignee: FUJIFILM Corporation, Tokyo (JP)

(21) Appl. No.: 19/182,492

(22) Filed: Apr. 17, 2025

(30) Foreign Application Priority Data
Apr. 25, 2024 (JP) 2024-071771

(51) Int. Cl. G03B 21/28; G02B 13/16

(52) U.S. Cl. CPC G03B 21/28; G02B 13/16

(57) ABSTRACT

The imaging optical system consists of a reflective optical system and a refractive optical system including a plurality of lenses along an optical path in order from an enlargement side to a reduction side. The reflective optical system includes a first reflecting surface having a positive power, a second reflecting surface having a power, and a third reflecting surface having a positive power along the optical path in order from the enlargement side to the reduction side. A first intermediate image is formed at a position conjugate to a reduction-side imaging plane between the third reflecting surface and the refractive optical system, and a second intermediate image is formed at a position conjugate to the first intermediate image in the reflective optical system. Intermediate images formed closer to the enlargement side than the refractive optical system are only two intermediate images.

### CROSS-REFERENCE TO RELATED APPLICATIONS

This application claims priority from Japanese Patent Application No. 2024-071771, filed on Apr. 25, 2024, the entire disclosure of which is incorporated herein by reference.

### BACKGROUND

### Technical Field

The present disclosed technology relates to an imaging optical system, a projection type display device, and an imaging apparatus.

### Related Art

In the related art, as an imaging optical system that can be used in a projection type display device, an imaging apparatus, or the like, systems described in JP2020-024359A and JP2020-086174A are known.

### SUMMARY

There has been a demand for an imaging optical system that is small-sized and can achieve an increase in angle of view. A level of the demand has increased year by year.

The present disclosure provides an imaging optical system that is small-sized and can achieve an increase in angle of view, a projection type display device including the imaging optical system, and an imaging apparatus including the imaging optical system.

According to one aspect of the present disclosure, there is provided an imaging optical system consisting of a reflective optical system and a refractive optical system including a plurality of lenses along an optical path in order from an enlargement side to a reduction side, in which the reflective optical system includes a first reflecting surface having a positive power, a second reflecting surface having a power, and a third reflecting surface having a positive power along the optical path in order from the enlargement side to the reduction side, a first intermediate image is formed at a position conjugate to a reduction-side imaging plane on the optical path between the third reflecting surface and the refractive optical system, a second intermediate image is formed at a position conjugate to the first intermediate image in the reflective optical system, intermediate images formed closer to the enlargement side than the refractive optical system are only the first intermediate image and the second intermediate image, and Conditional Expression (1) represented by

4.6<tan ω<50 (1)
is satisfied.

Here, a maximum half angle of view of the enlargement side is represented by ω.

In a case where a magnification of the imaging optical system is represented by β, a distance on an optical axis from the first reflecting surface to an enlargement-side imaging plane is represented by DO, and a distance on the optical axis from the first reflecting surface to the reduction-side imaging plane is represented by d, it is preferable that the imaging optical system according to the above-described aspect satisfies Conditional Expression (2) represented by

$$77.5 < \vert β \times d / D 0 \vert < 200. \qquad ( 2 )$$

In a case where a distance between an optical axis and a reflection point having a longest distance from the optical axis among reflection points of a ray on the first reflecting surface is represented by RM1, a distance between the optical axis and a reflection point having a longest distance from the optical axis among reflection points of a ray on the second reflecting surface is represented by RM2, a distance between the optical axis and a reflection point having a longest distance from the optical axis among reflection points of a ray on the third reflecting surface is represented by RM3, and a maximum image height on the reduction-side imaging plane is represented by Y, it is preferable that the imaging optical system according to the above-described aspect satisfies Conditional Expression (3) represented by

$$10 < ( RM 1 + RM 2 + RM 3 ) / Y < 25. \qquad ( 3 )$$

In a case where a distance between an optical axis and a reflection point having a longest distance from the optical axis among reflection points of a ray on the first reflecting surface is represented by RM1, and a distance on the optical axis from the first reflecting surface to the reduction-side imaging plane is represented by d, it is preferable that the imaging optical system according to the above-described aspect satisfies Conditional Expression (4) represented by

$$0 \text{.1} < RM 1 / d < 0.5 . \qquad ( 4 )$$

In a case where a distance between an optical axis and a reflection point having a longest distance from the optical axis among reflection points of a ray on the third reflecting surface is represented by RM3, and a distance on the optical axis from the first reflecting surface to the reduction-side imaging plane is represented by d, it is preferable that the imaging optical system according to the above-described aspect satisfies Conditional Expression (5) represented by

$$0 \text{.1} < RM 3 / d < 0.4 . \qquad ( 5 )$$

The refractive optical system includes preferably three or more negative lenses and more preferably four or more negative lenses.

It is preferable that the second intermediate image is formed on the optical path between the first reflecting surface and the second reflecting surface.

In a case where a focal length of the first reflecting surface is represented by fM1, and a focal length of the third reflecting surface is represented by fM3, it is preferable that the imaging optical system according to the above-described aspect satisfies Conditional Expression (6) represented by

$$0.25 < fM 1 / fM 3 < 4. \qquad ( 6 )$$

The first reflecting surface and the third reflecting surface may be formed of the same member and have the same surface shape.

In a case where a spacing on an optical axis between the first reflecting surface and the second reflecting surface is represented by dM1M2, and a distance on the optical axis from the first reflecting surface to the reduction-side imaging plane is represented by d, it is preferable that the imaging optical system according to the above-described aspect satisfies Conditional Expression (7) represented by

$$0.2 < \vert dM 1 M 2 \vert / d < 0.5 . \qquad ( 7 )$$

It is preferable that a lens closest to the reduction side in the refractive optical system has a positive power, and in a case where an Abbe number of the lens closest to the reduction side in the refractive optical system with respect to a d line is represented by vp, it is preferable that the imaging optical system according to the above-described aspect satisfies Conditional Expression (8) represented by

$$40 < vp < 100. \qquad ( 8 )$$

It is preferable that a lens closest to the reduction side in the refractive optical system includes a lens surface having an aspherical shape.

It is preferable that at least one of a lens closest to the enlargement side in the refractive optical system or a second lens from the enlargement side in the refractive optical system is a first negative lens having a negative power. It is preferable that the first negative lens includes a lens surface having an aspherical shape.

The number of lenses in the refractive optical system may be 6 or less. The number of lenses in the refractive optical system may be 10 or more.

According to another aspect of the present disclosure, there is provided a projection type display device including the imaging optical system according to the above-described aspect.

According to still another aspect of the present disclosure, there is provided an imaging apparatus including the imaging optical system according to the above-described aspect.

In the present specification, it should be noted that the terms “consisting of” and “consists of” mean that the lens may include not only the above-described components but also lenses substantially having no power, optical elements, which are not lenses, such as a stop, a mask, a filter, a cover glass, a plane mirror, and a prism, and mechanism parts such as a lens flange, a lens barrel, an imaging element, and a camera shaking correction mechanism.

The sign of the power and the surface shape relating to an optical member including an aspheric surface are considered in a paraxial region unless otherwise specified. The “focal length” used in a conditional expression is a paraxial focal length. Unless otherwise specified, the “distance on the optical axis” used in Conditional Expression is considered as a geometrical distance.

The “d line”, “C line”, and “F line” described in the present specification are emission lines, the wavelength of the d line is 587.56 nanometers (nm), the wavelength of the C line is 656.27 nanometers (nm), and the wavelength of the F line is 486.13 nanometers (nm).

The present disclosure can provide an imaging optical system that is small-sized and can achieve an increase in angle of view, a projection type display device including the imaging optical system, and an imaging apparatus including the imaging optical system.

### BRIEF DESCRIPTION OF THE DRAWINGS

FIG. 1 is a cross-sectional view showing a configuration and luminous fluxes of an imaging optical system according to an embodiment corresponding to an imaging optical system according to Example 1.

FIG. 2 is a diagram for describing symbols of conditional expressions.

FIG. 3 shows each of aberration diagrams in the imaging optical system according to Example 1.

FIG. 4 is a cross-sectional view showing a configuration and luminous fluxes of an imaging optical system according to Example 2.

FIG. 5 shows each of aberration diagrams in the imaging optical system according to Example 2.

FIG. 6 is a cross-sectional view showing a configuration and luminous fluxes of an imaging optical system according to Example 3.

FIG. 7 shows each of aberration diagrams in the imaging optical system according to Example 3.

FIG. 8 is a cross-sectional view showing a configuration and luminous fluxes of an imaging optical system according to Example 4.

FIG. 9 shows each of aberration diagrams in the imaging optical system according to Example 4.

FIG. 10 is a cross-sectional view showing a configuration and luminous fluxes of an imaging optical system according to Example 5.

FIG. 11 shows each of aberration diagrams in the imaging optical system according to Example 5.

FIG. 12 is a cross-sectional view showing a configuration and luminous fluxes of an imaging optical system according to Example 6.

FIG. 13 shows each of aberration diagrams in the imaging optical system according to Example 6.

FIG. 14 is a cross-sectional view showing a configuration and luminous fluxes of an imaging optical system according to Example 7.

FIG. 15 shows each of aberration diagrams in the imaging optical system according to Example 7.

FIG. 16 is a cross-sectional view showing a configuration and luminous fluxes of an imaging optical system according to Example 8.

FIG. 17 shows each of aberration diagrams in the imaging optical system according to Example 8.

FIG. 18 is a cross-sectional view showing a configuration and luminous fluxes of an imaging optical system according to Example 9.

FIG. 19 shows each of aberration diagrams in the imaging optical system according to Example 9.

FIG. 20 is a cross-sectional view showing a configuration and luminous fluxes of an imaging optical system according to Example 10.

FIG. 21 shows each of aberration diagrams in the imaging optical system according to Example 10.

FIG. 22 is a cross-sectional view showing a configuration and luminous fluxes of an imaging optical system according to Example 11.

FIG. 23 shows each of aberration diagrams in the imaging optical system according to Example 11.

FIG. 24 is a cross-sectional view showing a configuration and luminous fluxes of an imaging optical system according to a modification example of Example 11.

FIG. 25 is a cross-sectional view showing a configuration and luminous fluxes of an imaging optical system according to Example 12.

FIG. 26 shows each of aberration diagrams in the imaging optical system according to Example 12.

FIG. 27 is a cross-sectional view showing a configuration and luminous fluxes of an imaging optical system according to Example 13.

FIG. 28 shows each of aberration diagrams in the imaging optical system according to Example 13.

FIG. 29 is a cross-sectional view showing a configuration and luminous fluxes of an imaging optical system according to Example 14.

FIG. 30 shows each of aberration diagrams in the imaging optical system according to Example 14.

FIG. 31 is a cross-sectional view showing a configuration and luminous fluxes of an imaging optical system according to Example 15.

FIG. 32 shows each of aberration diagrams in the imaging optical system according to Example 15.

FIG. 33 is a schematic configuration diagram showing a projection type display device according to an embodiment.

FIG. 34 is a schematic configuration diagram showing a projection type display device according to another embodiment.

FIG. 35 is a schematic configuration diagram showing a projection type display device according to still another embodiment.

FIG. 36 is a schematic configuration diagram showing a projection type display device according to still another embodiment.

FIG. 37 is a perspective view showing a front side of an imaging apparatus according to an embodiment.

FIG. 38 is a perspective view showing a rear side of the imaging apparatus shown in FIG. 37.

### DETAILED DESCRIPTION

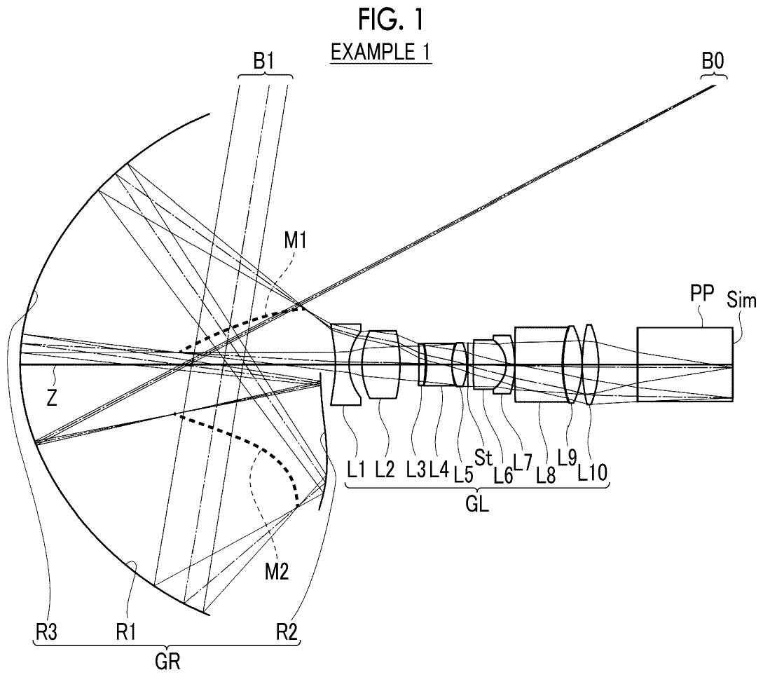

Hereinafter, an embodiment of the present disclosed technology will be described with reference to the drawings. FIG. 1 is a cross-sectional view showing a configuration and luminous fluxes in a cross section including an optical axis Z of an imaging optical system according to an embodiment of the present disclosure. The configuration example shown in FIG. 1 corresponds to Example 1 described below. In FIG. 1, as the luminous fluxes, a ray BO with the minimum angle of view and a ray BI with the maximum angle of view are shown.

The imaging optical system according to the present disclosure can also be mounted on a projection type display device to configure a projection optical system where a display element is disposed on a reduction-side imaging plane. In addition, the imaging optical system can also be mounted on a digital camera or the like to configure an imaging optical system where an imaging element is disposed on the reduction-side imaging plane. Hereinafter, the description will be made assuming a case where the imaging optical system according to the present disclosure is used for the projection optical system. In the following description, in order to avoid redundant description, “the imaging optical system of the present disclosure” will also be simply referred to as an “the imaging optical system”.

FIG. 1 shows an example in which an optical member PP and a display surface Sim of a light valve are disposed on a reduction side of the imaging optical system on the assumption that the imaging optical system is mounted on a projection type display device. The optical member PP is a member which is regarded as a filter, a cover glass, a color synthesis prism, or the like. The optical member PP has no power, and a configuration where the optical member PP is not provided can also be adopted. The light valve is a display element that outputs an optical image, and the optical image is displayed as an image on the display surface Sim. As the light valve, for example, a liquid crystal display element or an image display element such as digital micromirror device (DMD: registered trademark) can be used.

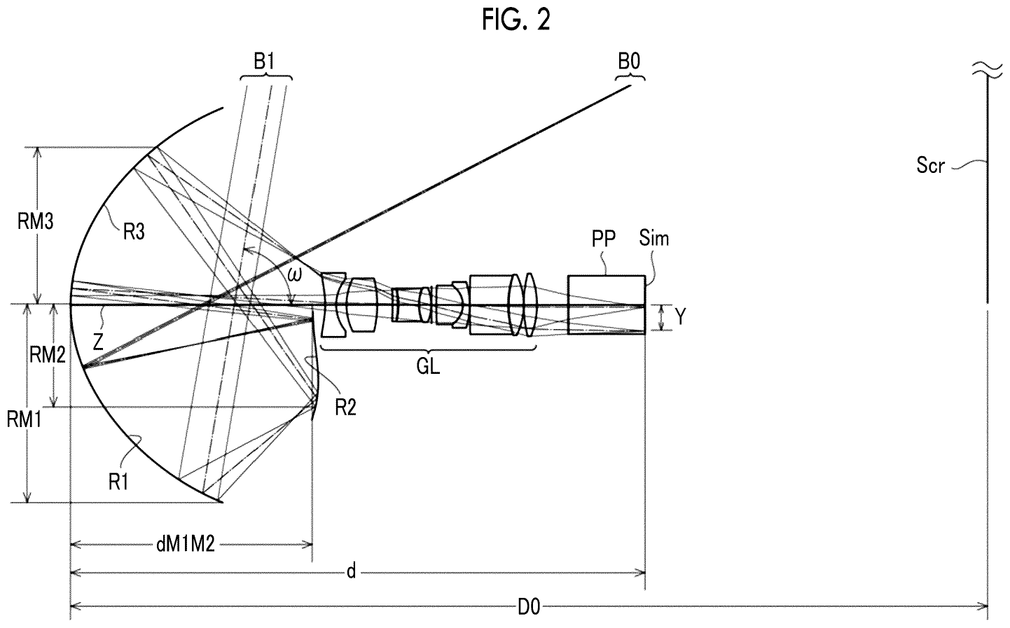

The imaging optical system is mounted on, for example, a projection type display device and projects an image displayed on the display surface Sim of the display element on the reduction side onto a projection surface on the enlargement side. In the projection type display device, a luminous flux provided with image information on the display surface Sim is incident into the imaging optical system through the optical member PP, and is projected onto a screen (for example, refer to reference numeral Scr in FIG. 2) that is a projection surface through the imaging optical system. That is, the display surface Sim and the screen are positioned at optically conjugate positions. The screen is an example of the “enlargement-side imaging plane” of the present disclosure, and the image display surface Sim is an example of the “reduction-side imaging plane” of the present disclosure. It should be noted that, in the present specification, the term “screen” means an object on which a projected image formed by the imaging optical system is projected. The screen may be, for example, not only a dedicated screen but also a wall surface of a room, a floor surface, a ceiling, an outer wall surface of a building, or the like.

In the description of the present specification, “the enlargement side” refers to the screen side on the optical path, and “the reduction side” refers to the display surface Sim side on the optical path. In the present specification, “the enlargement side” and “the reduction side” are determined along the optical path. For example, in the imaging optical system that forms a bent optical path, “a lens A is closer to the enlargement side than a lens B” has the same meaning as “the lens A is on the optical path to be closer to the enlargement side than the lens B”. Accordingly, in the imaging optical system that forms a bent optical path, “closest to the enlargement side” represents that a position is closest to the enlargement side in the arrangement order on the optical path, and does not represent that the position is closest to the screen in terms of distance. Hereinafter, in order to avoid redundant description, “along the optical path in order from the enlargement side to the reduction side” will also be referred to as “in order from the enlargement side to the reduction side”.

The imaging optical system according to the present disclosure consists of a reflective optical system GR and a refractive optical system GL including a plurality of lenses along the optical path in order from the enlargement side to the reduction side. The reflective optical system GR includes a first reflecting surface R1 having a positive power, a second reflecting surface R2 having a power, and a third reflecting surface R3 having a positive power along the optical path in order from the enlargement side to the reduction side.

Chromatic aberration does not occur on the reflecting surface itself. Therefore, by disposing three reflecting surfaces on the enlargement side in the imaging optical system, the occurrence of chromatic aberration in the entire optical system can be reduced. In addition, an optical path length can be easily ensured by the optical path where a ray is reflected three times. Therefore, the size can be reduced while achieving a wide angle, and further the power of each of optical elements can be reduced. As a result, a load on aberration correction and the like of the refractive optical system GL can be reduced, and thus the number of lenses of the refractive optical system GL can be reduced, which contributes to a reduction in size.

For example, the first reflecting surface R1, the second reflecting surface R2, and the third reflecting surface R3 of FIG. 1 consist of mirror surfaces. For example, the refractive optical system GL of FIG. 1 consists of lenses L1 to L5, an aperture stop St, and lenses L6 to L10 in order from the enlargement side to the reduction side. The aperture stop St shown in FIG. 1 does not show the size or the shape thereof, but shows a position thereof in the optical axis direction. For example, the refractive optical system GL and the reflective optical system GR of FIG. 1 have the common optical axis Z. The configuration of the coaxial system can be set up more easily than a configuration other than the coaxial system. In a case where an optical surface of an optical component has a rotational symmetrical axis, the rotational symmetrical axis corresponds to the optical axis Z.

In the imaging optical system of FIG. 1, a luminous flux from the display surface Sim to the enlargement side transmits through the optical member PP, transmits through the refractive optical system GL, and forms a first intermediate image M1. Next, the luminous flux is incident into the third reflecting surface R3 to be reflected from the third reflecting surface R3, is incident into the second reflecting surface R2 to be reflected from the second reflecting surface R2, and forms a second intermediate image M2. Next, the luminous flux is incident into the first reflecting surface R1 to be reflected from the first reflecting surface R1, and forms a projected image on the screen (not shown in FIG. 1).

The imaging optical system according to the present disclosure forms at least two intermediate images including the first intermediate image M1 and the second intermediate image M2 as images conjugate to the image displayed on the display surface Sim. By forming the intermediate images, the focal length of the entire system can be reduced to achieve a configuration suitable for increasing the angle of view. In addition, at least two intermediate images are formed which is advantageous in realizing an ultra-wide-angle optical system. In FIG. 1, the first intermediate image M1 and the second intermediate image M2 are indicated by conceptually thick broken lines. The shape of the first intermediate image M1 and the second intermediate image M2 shown in FIG. 1 is not necessarily accurate.

The first intermediate image M1 is formed at a position conjugate to the reduction-side imaging plane on the optical path between the third reflecting surface R3 and the refractive optical system GL. By not forming the first intermediate image M1 in the refractive optical system GL, projection of scratches and/or dust of a lens can be suppressed, which is advantageous in forming a favorable projected image.

The second intermediate image M2 is formed at a position conjugate to the first intermediate image M1 in the reflective optical system GR. “In the reflective optical system GR” refers to the inside of the optical path from a surface closest to the enlargement side in the reflective optical system GR to a surface closest to the reduction side in the reflective optical system GR. By forming the second intermediate image M2 in the reflective optical system GR, projection of scratches and/or dust of a lens can be suppressed, which is advantageous in forming a favorable projected image.

It is preferable that the second intermediate image M2 is formed on the optical path between the first reflecting surface R1 and second reflecting surface R2. In this case, projection of scratches and/or dust of a reflecting surface can be suppressed, which is advantageous in forming a favorable projected image.

It is preferable that intermediate images formed closer to the enlargement side than the refractive optical system GL are only two intermediate images including the first intermediate image M1 and the second intermediate image M2. In this case, this configuration is advantageous in reducing the size while realizing a wide-angle optical system. In addition, in order to reduce the size, the intermediate images formed by the imaging optical system may be configured to be only the two intermediate images including the first intermediate image M1 and the second intermediate image M2.

A refraction member may be configured not to be disposed on the optical path between the first reflecting surface R1 and the second reflecting surface R2. In a case where the refraction member is disposed on the optical path between the first reflecting surface R1 and the second reflecting surface R2, there is a defect that projection of scratches and/or dust of the refraction member may occur. By not disposing the refraction member, this defect can be avoided. In addition, this configuration can contribute to simplifying the device configuration. Due to the same reason, the refraction member may be configured not to be disposed on the optical path between the second reflecting surface R2 and the third reflecting surface R3.

It is preferable that the first reflecting surface R1 and the third reflecting surface R3 are formed of the same member and have the same surface shape. In this case, the time and the number of processes required for, for example, a relative alignment process of the reflecting surfaces during manufacturing can be reduced, which can contribute to cost reduction. In addition, performance deterioration caused by relative misalignment of the reflecting surfaces during manufacturing can be suppressed, which is advantageous in ensuring the performance.

“Being formed of the same member and having the same surface shape” represents a continuous surface having a shape that is formed based on the same design data. “The same design data” represents that curvature radii are the same in the case of a spherical shape, represents that aspheric equations and aspherical coefficients are the same in the case of an aspherical shape, and represents that free-form surface equations and free-form surface coefficients are the same in the case of a free-form surface shape.

It is preferable that the refractive optical system GL includes three or more negative lenses. In this case, this configuration is advantageous in correcting various aberrations. The refractive optical system GL includes four or more negative lenses, which is advantageous in correcting various aberrations.

It is preferable that at least one of a lens closest to the enlargement side in the refractive optical system GL or a second lens from the enlargement side in the refractive optical system GL is a first negative lens having a negative power. In this case, this configuration is advantageous in correcting field curvature occurring on the reflecting surface.

It is preferable that the first negative lens includes a lens surface having an aspherical shape. In this case, this configuration is advantageous in correcting field curvature occurring on the reflecting surface.

It is preferable that a lens closest to the reduction side in the refractive optical system GL has a positive power. In this case, this configuration is advantageous in ensuring telecentricity of the reduction side of the imaging optical system.

It is preferable that the lens closest to the reduction side in the refractive optical system GL includes a lens surface having an aspherical shape. In this case, this configuration is advantageous in suppressing field curvature.

It is preferable that the number of lenses in the refractive optical system GL is six or less. In this case, this configuration is advantageous in reducing the size and the weight.

It is preferable that the number of lenses in the refractive optical system GL is 10 or more. In this case, this configuration is advantageous in correcting aberrations in a case where a large display element is used.

It is preferable that the refractive optical system GL includes a lens group where lenses adjacent to each other are at least partially in contact with each other. In this case, this configuration is advantageous in correcting chromatic aberration. In particular, in a case where the refractive optical system GL includes two or more lens groups where a lens having a positive power and a lens having a negative power are at least partially in contact with each other, this configuration is advantageous in correcting various aberrations. “The lens group where lenses adjacent to each other are at least partially in contact with each other” may be a cemented lens, or may have a configuration where only edge parts of lenses that are so-called edge contacts are in contact with each other.

Next, preferable and possible configurations about conditional expressions of the imaging optical system according to the present disclosure will be described. In the following description relating to the conditional expressions, in order to avoid redundant description, factors having the same definition will be represented by the same symbols, and the description thereof will not be repeated.

In a case where a maximum half angle of view of the enlargement side is represented by w, it is preferable that the imaging optical system satisfies Conditional Expression (1). ω represents the maximum angle among angles between the optical axis Z and a principal ray from a surface closest to the enlargement side in the imaging optical system to the enlargement-side imaging plane. By setting the corresponding value of Conditional Expression (1) not to be the lower limit value or less, an ultra-wide-angle optical system can be realized. By setting the corresponding value of Conditional Expression (1) not to be the upper limit value or more, shielding of a ray caused by relatively fine unevenness of a wall surface of the screen can be suppressed.

$$4.6 < tan ω < 50 \qquad ( 1 )$$

In order to obtain more favorable characteristics, the lower limit value of Conditional Expression (1) is more preferably 4.8 and still more preferably 5.

FIG. 2 is a configuration diagram showing a cross section including the optical axis Z of the imaging optical system of FIG. 1. For example, the above-described maximum half angle of view ω is shown. FIG. 2 shows the screen Scr and does not show the reference numerals of each of the intermediate images and each of the lenses.

It is preferable that the imaging optical system satisfies Conditional Expression (2). Here, a magnification of the imaging optical system is represented by β. A distance on the optical axis from the first reflecting surface R1 to the enlargement-side imaging plane is represented by D0. A distance on the optical axis from the first reflecting surface R1 to the reduction-side imaging plane is represented by d. B represents a lateral magnification instead of a vertical magnification. For example, FIG. 2 shows the distance D0 and the distance d. By setting the corresponding value of Conditional Expression (2) not to be the lower limit value or less, projection at a wide angle of view can be performed. By setting the corresponding value of Conditional Expression (2) not to be the upper limit value or more, this configuration is advantageous in reducing the total length.

$$77.5 < \vert β \times d / D0 \vert < 200 \qquad ( 2 )$$

In order to obtain more favorable characteristics, the lower limit value of Conditional Expression (2) is more preferably 80 and still more preferably 82.5. In order to obtain more favorable characteristics, the upper limit value of Conditional Expression (2) is more preferably 175 and still more preferably 150.

In the example of FIG. 1, an intersection between the first reflecting surface R1 and the optical axis Z is present. Unlike the example of FIG. 1, in a case where an intersection between the first reflecting surface R1 and the optical axis Z is not present, the distance d is determined as follows. Assuming a virtual plane obtained by extending the shape of the first reflecting surface R1 to the optical axis Z based on the design data of the shape of the first reflecting surface R1, an intersection between the virtual plane and the optical axis Z is an end point of the distance d on the first reflecting surface side.

It is preferable that the imaging optical system satisfies Conditional Expression (3). Here, a distance between the optical axis Z and a reflection point having a longest distance from the optical axis Z among reflection points of a ray on the first reflecting surface is represented by RM1. Here, a distance between the optical axis Z and a reflection point having a longest distance from the optical axis Z among reflection points of a ray on the second reflecting surface is represented by RM2. Here, a distance between the optical axis Z and a reflection point having a longest distance from the optical axis Z among reflection points of a ray on the third reflecting surface is represented by RM3. A maximum image height on the reduction-side imaging plane is represented by Y. The “ray” regarding RM1, RM2, and RM3 refers to a ray used for imaging on the enlargement-side imaging plane or the reduction-side imaging plane. For example, FIG. 2 shows the distance RM1, the distance RM2, and the distance RM3, and the maximum image height Y. By setting the corresponding value of Conditional Expression (3) not to be the lower limit value or less, this configuration is advantageous in increasing the angle of view. By setting the corresponding value of Conditional Expression (3) not to be the upper limit value or more, this configuration is advantageous in reducing the size.

$$10 < ( RM 1 + RM 2 + RM 3 ) / Y < 25 \qquad ( 3 )$$

In order to obtain more favorable characteristics, the lower limit value of Conditional Expression (3) is more preferably 11 and still more preferably 12. In order to obtain more favorable characteristics, the upper limit value of Conditional Expression (3) is more preferably 22.5 and still more preferably 20.

It is preferable that the imaging optical system satisfies Conditional Expression (4). By setting the corresponding value of Conditional Expression (4) not to be the lower limit value or less, this configuration is advantageous in increasing the angle of view. By setting the corresponding value of Conditional Expression (4) not to be the upper limit value or more, an increase in size in a direction perpendicular to the optical axis Z can be suppressed.

$$0.1 < RM 1 / d < 0.5 \qquad ( 4 )$$

In order to obtain more favorable characteristics, the lower limit value of Conditional Expression (4) is more preferably 0.15 and still more preferably 0.2. In order to obtain more favorable characteristics, the upper limit value of Conditional Expression (4) is more preferably 0.45 and still more preferably 0.4.

It is preferable that the imaging optical system satisfies Conditional Expression (5). By setting the corresponding value of Conditional Expression (5) not to be the lower limit value or less, this configuration is advantageous in increasing the angle of view. By setting the corresponding value of Conditional Expression (5) not to be the upper limit value or more, an increase in size in a direction perpendicular to the optical axis Z can be suppressed.

$$0.1 < RM 3 / d < 0.4 \qquad ( 5 )$$

In order to obtain more favorable characteristics, the lower limit value of Conditional Expression (5) is more preferably 0.15 and still more preferably 0.2. In order to obtain more favorable characteristics, it is more preferable that the upper limit value of Conditional Expression (5) is 0.35.

In a case where a focal length of the first reflecting surface R1 is represented by fM1 and a focal length of the third reflecting surface R3 is represented by fM3, it is preferable that the imaging optical system satisfies Conditional Expression (6). By setting the corresponding value of Conditional Expression (6) not to be the lower limit value or less, a curvature of the third reflecting surface R3 can be reduced. Therefore, a spacing between the second reflecting surface R2 and the third reflecting surface R3 is not excessively long, and thus an increase in the size of the third reflecting surface R3 can be suppressed. By setting the corresponding value of Conditional Expression (6) not to be the upper limit value or more, a curvature of the first reflecting surface R1 can be reduced. Therefore, a spacing between the first reflecting surface R1 and the second reflecting surface R2 is not excessively long, and thus, a luminous flux having a wide angle of view that is reflected from the first reflecting surface R1 can be prevented from being shielded by the third reflecting surface R3.

$$0.25 < fM 1 / fM 4 < 4 \qquad ( 6 )$$

In order to obtain more favorable characteristics, the lower limit value of Conditional Expression (6) is more preferably 0.5 and still more preferably 0.8. In order to obtain more favorable characteristics, the upper limit value of Conditional Expression (6) is more preferably 2 and still more preferably 1.25.

In a case where a spacing on the optical axis between the first reflecting surface R1 and the second reflecting surface R2 is represented by dMIM2, it is preferable that the imaging optical system satisfies Conditional Expression (7). For example, FIG. 2 shows the above-described spacing dMIM2. By setting the corresponding value of Conditional Expression (7) not to be the lower limit value or less, the length in the optical axis direction required as the reflective optical system GR according to the present disclosure can be ensured. By setting the corresponding value of Conditional Expression (7) not to be the upper limit value or more, the length of the refractive optical system GL can be easily ensured, which is advantageous in favorably correcting geometric aberration in the refractive optical system GL.

$$0.2 < \vert dM 1 M 2 \vert / d < 0.5 \qquad ( 7 )$$

In order to obtain more favorable characteristics, the lower limit value of Conditional Expression (7) is more preferably 0.25 and still more preferably 0.3. In order to obtain more favorable characteristics, it is more preferable that the upper limit value of Conditional Expression (7) is 0.45.

In the example of FIG. 1, an intersection between the first reflecting surface R1 and the optical axis Z is present. Unlike the example of FIG. 1, in a case where an intersection between the first reflecting surface R1 and the optical axis Z is not present, the spacing dM1M2 is determined as follows. Assuming a virtual plane obtained by extending the shape of the first reflecting surface R1 to the optical axis Z based on the design data of the shape of the first reflecting surface R1, an intersection between the virtual plane and the optical axis Z is an end point of the spacing dMIM2 on the first reflecting surface side. Likewise, in a case where an intersection between the second reflecting surface R2 and the optical axis Z is not present, assuming a virtual plane obtained by extending the shape of the second reflecting surface R2 to the optical axis Z based on the design data of the shape of the second reflecting surface R2, an intersection between the virtual plane and the optical axis Z is an end point of the spacing dM1M2 on the second reflecting surface side.

In a configuration where the lens closest to the reduction side in the refractive optical system GL has a positive power, it is preferable that the imaging optical system satisfies Conditional Expression (8). An Abbe number of the lens closest to the reduction side with respect to the d line is represented by vp. By setting the corresponding value of Conditional Expression (8) not to be the lower limit value or less, a low-dispersion material can be used, which is advantageous in suppressing the occurrence of chromatic aberration. By setting the corresponding value of Conditional Expression (8) not to be the upper limit value or more, an optical material having excellent availability can be used.

$$40 < vp < 100 \qquad ( 8 )$$

In order to obtain more favorable characteristics, the lower limit value of Conditional Expression (8) is more preferably 45 and still more preferably 50.

The above preferable configurations and available configurations including the configurations related to the conditional expressions can be combined in any manner and are preferably selectively adopted, as appropriate, in accordance with required specifications. The example of FIG. 1 is merely exemplary, and various modifications can be made without departing from the scope of the present disclosed technology.

For example, in the present disclosed technology, the number of lenses and the number of reflecting surfaces in the imaging optical system may be different from those in the example of FIG. 1. The reflective optical system GR may be configured to consist of the three reflecting surfaces, or may include an optical member other than the three reflecting surfaces. The reflecting surface is not limited to a mirror surface and may be, for example, a surface formed on a surface of a lens or a surface formed on a surface of a prism. The refractive optical system GL may include an optical member other than a lens. For example, the refractive optical system GL may include a plane mirror. The imaging optical system may include an optical path bending member not having a power to bend the optical path. As the optical path bending member, for example, a plane mirror or a reflecting surface of a prism can be used.

For example, one preferable aspect of the imaging optical system according to the present disclosure consists of a reflective optical system GR and a refractive optical system GL including a plurality of lenses along the optical path in order from the enlargement side to the reduction side, in which the reflective optical system GR includes a first reflecting surface R1 having a positive power, a second reflecting surface R2 having a power, and a third reflecting surface R3 having a positive power along the optical path in order from the enlargement side to the reduction side, a first intermediate image M1 is formed at a position conjugate to a reduction-side imaging plane on the optical path between the third reflecting surface R3 and the refractive optical system GL, a second intermediate image M2 is formed at a position conjugate to the first intermediate image M1 in the reflective optical system GR, intermediate images formed closer to the enlargement side than the refractive optical system GL are only the first intermediate image M1 and the second intermediate image M2, and Conditional Expression (1) is satisfied.

Next, examples of the imaging optical system of the present disclosure will be described, with reference to the drawings. The reference numerals added to the components of the imaging optical system in a cross-sectional view of each of examples are used independently for each example in order to avoid complication of description and drawings due to an increase in the number of digits of the reference numerals. Therefore, even in a case where common reference numerals are added in the drawings of different examples, components do not necessarily have a common configuration.

### Example 1

FIG. 1 is a cross-sectional view of a configuration and luminous flux of an imaging optical system of Example 1, and an illustration method and a configuration thereof are as described above. Therefore, some description is not repeated herein. The imaging optical system according to Example 1 consists of a reflective optical system GR and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The first reflecting surface R1 and the third reflecting surface R3 are formed of the same member and have the same surface shape. The refractive optical system GL consists of lenses L1 to L5, an aperture stop St, and lenses L6 to L10 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

Regarding the imaging optical system according to Example 1, Table 1 shows basic lens data, Table 2 shows specifications, and Table 3 shows aspherical coefficients.

The table of the basic lens data is described as follows. The “Sn” column shows surface numbers in a case where the surface closest to the enlargement side is the first surface and the number is increased one by one toward the reduction side. The R column shows a curvature radius of each surface. The D column shows a surface spacing between each surface and the surface adjacent to the reduction side on the optical axis. The Nd column shows a refractive index of each component with respect to the d line. The vd column shows an Abbe number of each component with respect to the d line. “Reflecting surface” is filled in the outside of the row corresponding to each of the reflecting surfaces.

In the table of the basic lens data, the sign of the curvature radius of a surface that is convex to the enlargement side is positive, and the sign of the curvature radius of a surface that is convex to the reduction side is negative. In the fields of the surface number of the surface corresponding to the aperture stop St, the surface number and the expression (St) are shown. The table of basic lens data also shows the optical member PP. The value in the bottom field of the column D in the table indicates a spacing between the display surface Sim and the surface closest to the reduction side in the table.

Table 2 shows a focal length f, a back focus Bf in terms of an air conversion distance, a F-number FNo., a maximum total angle of view 2ω with respect to the d line. [°] in the fields of 2ω indicates that the unit thereof is degree.

In the basic lens data, a reference sign * is added to surface numbers of aspherical surfaces, and values of paraxial curvature radius are shown in the fields of the curvature radius of the aspherical surface. In Table 3, the Sn row shows surface numbers of the aspherical surfaces, and the KA and Am rows show numerical values of the aspherical coefficients for each aspherical surface. Here, m of Am represents an integer of 3 or more and varies depending on the surface. For example, in the first surface of Example 1, m=3, 4, 5, . . . , and 16. The “E±n” (n: an integer) in the numerical values of the aspherical coefficients of Table 3 indicates “×10^{±n}”. KA and Am represent the aspherical coefficients in an aspheric equation represented by the following expression.

$$Zd = C \times {h}^{2} / \{ 1 + {( 1 - KA \times {C}^{2} \times {h}^{2} )}^{1 / 2} \} + Σ Am \times {h}^{m}$$

where,
Zd is an aspherical surface depth (a length of a perpendicular from a point on an aspherical surface at a height h to a plane that is perpendicular to the optical axis Z and in contact with the aspherical surface apex),
h is a height (a distance from the optical axis Z to the lens surface),
C is a reciprocal of the paraxial curvature radius,
KA and Am are aspherical coefficients, and
Σ in the aspheric equation represents the total sum regarding m.

In the data of each of the tables, degrees are used as the unit of an angle, and millimeters (mm) are used as the unit of a length. However, appropriate different units may be used because the optical system can be used even in a case where the system is enlarged or reduced in proportion. Further, each of the following tables shows numerical values rounded off to predetermined decimal places.

TABLE 1
Example 1

| Sn | R | D | Nd | νd | |
|---|---|---|---|---|---|
| *1 | 70.0885 | 94.6991 | | | Reflecting Surface |
| *2 | 157.4150 | −94.6991 | | | Reflecting Surface |
| *3 | 70.0885 | 99.5053 | | | Reflecting Surface |
| *4 | −37.5930 | 4.3036 | 1.69350 | 53.18 | |
| 5 | 17.9784 | 4.0630 | | | |
| 6 | 26.4968 | 12.0007 | 1.69895 | 30.13 | |
| 7 | −51.8478 | 6.0418 | | | |
| 8 | −129.3107 | 2.0004 | 1.48749 | 70.44 | |
| 9 | −42.7442 | 0.3527 | | | |
| 10 | −30.9993 | 8.0009 | 1.77250 | 49.62 | |
| 11 | 24.0472 | 0.0291 | | | |
| 12 | 17.8434 | 4.7368 | 1.48749 | 70.44 | |
| 13(St) | −20.3214 | 2.0002 | | | |
| 14 | 176.3121 | 10.4166 | 1.48749 | 70.44 | |
| 15 | −10.1298 | 2.6806 | 1.83481 | 42.72 | |
| 16 | −34.1948 | 0.0295 | | | |
| 17 | 400.9263 | 14.9996 | 1.80420 | 46.50 | |
| 18 | 41.7498 | 0.2756 | | | |
| 19 | 45.3721 | 5.8539 | 1.59282 | 68.62 | |
| 20 | −30.7867 | 0.0307 | | | |
| 21 | 57.6703 | 5.1536 | 1.51633 | 64.06 | |
| *22 | −38.8587 | 12.2900 | | | |
| 23 | ∞ | 30.0900 | 1.51680 | 64.20 | |
| 24 | ∞ | 0.0513 | | | |

TABLE 2
Example 1

| | |
|---|---|
| f | 1.84 |
| Bf | 32.17 |
| FNo. | 2.00 |
| 2ω[°] | 162.0 |

TABLE 3
Example 1

| Sn | 1 | 2 | 3 |
|---|---|---|---|
| KA | 5.8104022E−01 | 9.9999963E+00 | 5.8104022E−01 |
| A3 | −3.7193399E−07 | −8.9976237E−05 | −3.7193399E−07 |
| A4 | 2.1058675E−07 | 1.2718109E−05 | 2.1058675E−07 |
| A5 | −1.3897022E−08 | −1.1305394E−07 | −1.3897022E−08 |
| A6 | −6.8984901E−11 | −3.6550626E−08 | −6.8984901E−11 |
| A7 | 7.8993873E−12 | 1.0275146E−09 | 7.8993873E−12 |
| A8 | −6.9037446E−15 | 1.9473856E−11 | −6.9037446E−15 |
| A9 | −2.7915273E−15 | −1.0060182E−12 | −2.7915273E−15 |
| A10 | 1.6530187E−17 | 1.1866955E−16 | 1.6530187E−17 |
| A11 | 4.6407042E−19 | 4.0259044E−16 | 4.6407042E−19 |
| A12 | −4.0646212E−21 | −2.7634377E−18 | −4.0646212E−21 |
| A13 | −3.5010739E−23 | −7.3828352E−20 | −3.5010739E−23 |
| A14 | 3.7025844E−25 | 7.5874800E−22 | 3.7025844E−25 |
| A15 | 9.8287580E−28 | 5.1248138E−24 | 9.8287580E−28 |
| A16 | −1.1654298E−29 | −6.3042846E−26 | −1.1654298E−29 |

| Sn | 4 | 22 |
|---|---|---|
| KA | 1.0000000E+00 | 1.0000000E+00 |
| A4 | 4.5517561E−05 | −4.0556353E−06 |
| A6 | −2.0598431E−07 | 9.4824998E−09 |
| A8 | 1.6843918E−09 | −5.2243700E−12 |
| A10 | −8.9115898E−12 | −2.6527802E−14 |
| A12 | 1.8500563E−14 | |
| A14 | 2.1085209E−17 | |
| A16 | −9.7761414E−20 | |

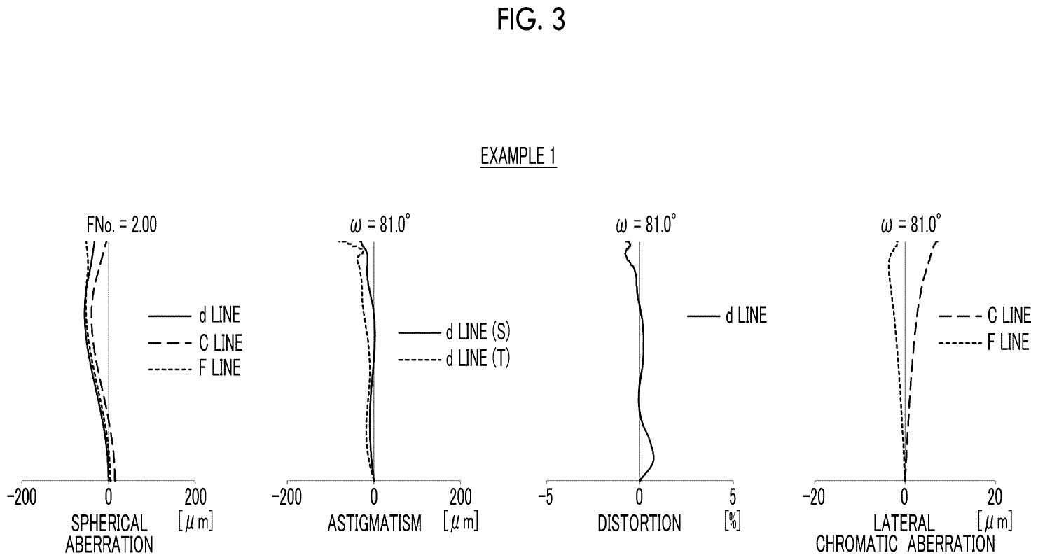

FIG. 3 shows each of aberration diagrams in the imaging optical system according to Example 1 in a state where the projection distance is 0.350 meters (m). “The projection distance” is a distance on the optical axis from the enlargement-side imaging plane to the reflecting surface closest to the enlargement side in the imaging optical system. FIG. 3 shows spherical aberration, astigmatism, distortion, and lateral chromatic aberration in order from the left side. In the spherical aberration diagram, aberrations regarding the d line, the C line, and the F line are indicated by a solid line, a long broken line, and a short broken line, respectively. In the astigmatism diagram, an aberration regarding the d line in the sagittal direction is indicated by a solid line, and an aberration regarding the d line in the tangential direction is indicated by a short broken line. In the distortion diagram, an aberration regarding the d line is indicated by a solid line. In the lateral chromatic aberration diagram, aberrations regarding the C line and the F line are indicated by a long broken line and a short broken line, respectively. In the spherical aberration diagram, a value of the F-number is shown after “FNoO.=”. In other aberration diagrams, the value of the maximum half angle of view is shown after “ω=”.

Symbols, meanings, description methods, and illustration methods of the respective data pieces according to Example 1 are basically similar to those in the following examples unless otherwise specified. Therefore, hereinafter, repeated description will not be given.

### Example 2

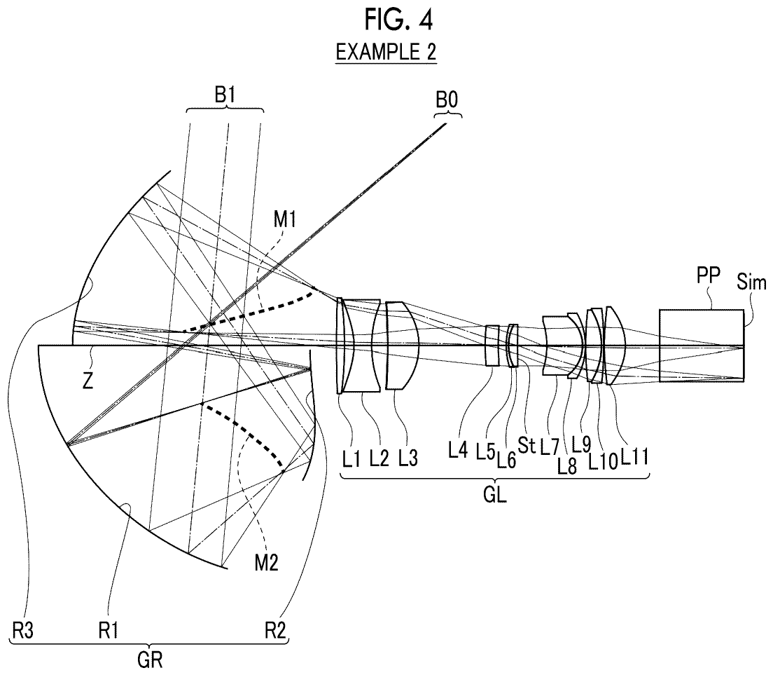

FIG. 4 is a cross-sectional view showing a configuration and luminous fluxes of an imaging optical system according to Example 2. The imaging optical system according to Example 2 consists of a reflective optical system GR and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The refractive optical system GL consists of lenses L1 to L6, an aperture stop St, and lenses L7 to L11 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

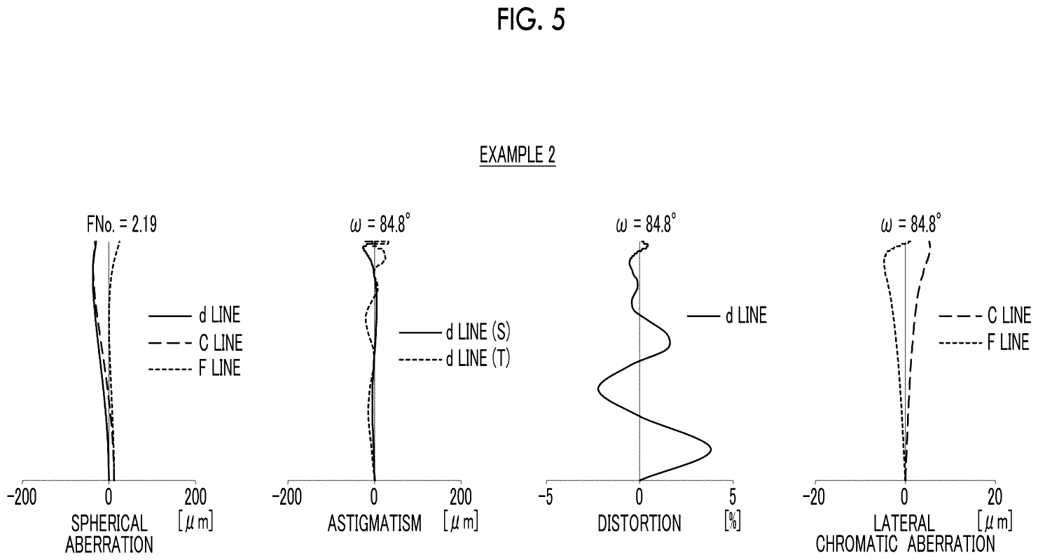

Regarding the imaging optical system according to Example 2, Table 4 shows basic lens data, Table 5 shows specifications, Table 6 shows aspherical coefficients, and FIG. 5 shows each of aberration diagrams in a state where the projection distance is 0.255 meters (m).

TABLE 4
Example 2

| Sn | R | D | Nd | νd | |
|---|---|---|---|---|---|
| *1 | 69.0780 | 97.1646 | | | Reflecting |
| | | | | | Surface |
| *2 | 115.9484 | −84.9678 | | | Reflecting |
| | | | | | Surface |
| *3 | 58.6129 | 94.4289 | | | Reflecting |
| | | | | | Surface |
| 4 | 500.0000 | 2.8950 | 1.84666 | 23.78 | |
| 5 | −139.4545 | 3.3854 | | | |
| *6 | −24.3818 | 6.3211 | 1.76450 | 49.10 | |
| 7 | 42.2369 | 5.6093 | | | |
| 8 | −266.2675 | 11.1087 | 1.43700 | 95.10 | |
| 9 | −24.7687 | 23.6794 | | | |
| 10 | 67.8589 | 4.7408 | 1.86966 | 20.02 | |
| 11 | 113.6408 | 2.8196 | | | |
| 12 | 27.2473 | 0.8010 | 1.80420 | 46.50 | |
| 13 | 16.9347 | 0.0502 | | | |
| 14 | 17.1536 | 3.2380 | 1.48749 | 70.44 | |
| 15(St) | 1808.4665 | 10.4373 | | | |
| 16 | −30.0619 | 12.7814 | 1.48749 | 70.44 | |
| 17 | −13.7698 | 0.9997 | 1.87070 | 40.73 | |
| 18 | −25.2899 | 0.0991 | | | |
| 19 | 118.0186 | 5.6815 | 1.59282 | 68.62 | |
| 20 | −26.2489 | 0.7999 | 1.80420 | 46.50 | |
| 21 | −129.1262 | 0.2000 | | | |
| *22 | 83.0722 | 7.5283 | 1.49700 | 81.61 | |
| *23 | −20.3892 | 12.2900 | | | |
| 24 | ∞ | 30.0900 | 1.51680 | 64.20 | |
| 25 | ∞ | 0.0508 | | | |

TABLE 5
Example 2

| | |
|---|---|
| f | 1.15 |
| Bf | 32.17 |
| FNo. | 2.19 |
| 2ω[°] | 169.6 |

TABLE 6
Example 2

| Sn | 1 | 2 | 3 |
|---|---|---|---|
| KA | 6.2310280E−01 | 3.9038253E+00 | 3.8038492E−02 |
| A3 | −2.2274506E−05 | −6.2177818E−05 | 2.7490561E−06 |
| A4 | 8.2698572E−07 | 5.9669729E−07 | −9.4493186E−07 |
| A5 | 3.2754170E−08 | 2.4483807E−07 | 3.5676281E−08 |
| A6 | −1.4811608E−09 | −2.1588202E−08 | −6.7746513E−10 |
| A7 | −9.5882579E−12 | 2.2095803E−10 | −1.5529893E−11 |
| A8 | 7.4398296E−13 | 1.6600439E−11 | 1.0087852E−12 |
| A9 | −8.3754329E−16 | −3.4884722E−13 | −9.5309283E−15 |
| A10 | −1.6238548E−16 | −4.5955809E−15 | −2.7924079E−16 |
| A11 | 5.9982361E−19 | 1.5182851E−16 | 5.5956379E−18 |
| A12 | 1.7300642E−20 | 3.0055912E−19 | 1.4137729E−20 |
| A13 | −7.3584090E−23 | −2.8170896E−20 | −9.3274233E−22 |
| A14 | −8.7601003E−25 | 6.5904201E−23 | 3.2991391E−24 |
| A15 | 2.8415104E−27 | 1.9240193E−24 | 5.1232084E−26 |
| A16 | 1.6503742E−29 | −8.2710970E−27 | −3.1686037E−28 |
| Sn | 6 | 22 | 23 |
| KA | 1.0000000E+00 | 1.0000000E+00 | 1.0000000E+00 |
| A4 | 5.6747070E−05 | −8.4522106E−06 | 1.2120375E−05 |
| A6 | −1.9498955E−07 | 1.5370673E−09 | 9.3616711E−09 |
| A8 | 1.0867483E−09 | 6.2982196E−11 | 8.9858877E−11 |
| A10 | −5.2121464E−12 | −1.9569357E−13 | −8.9198020E−14 |
| A12 | 1.6564685E−14 | | |
| A14 | −2.8938668E−17 | | |
| A16 | 2.1153248E−20 | | |

### Example 3

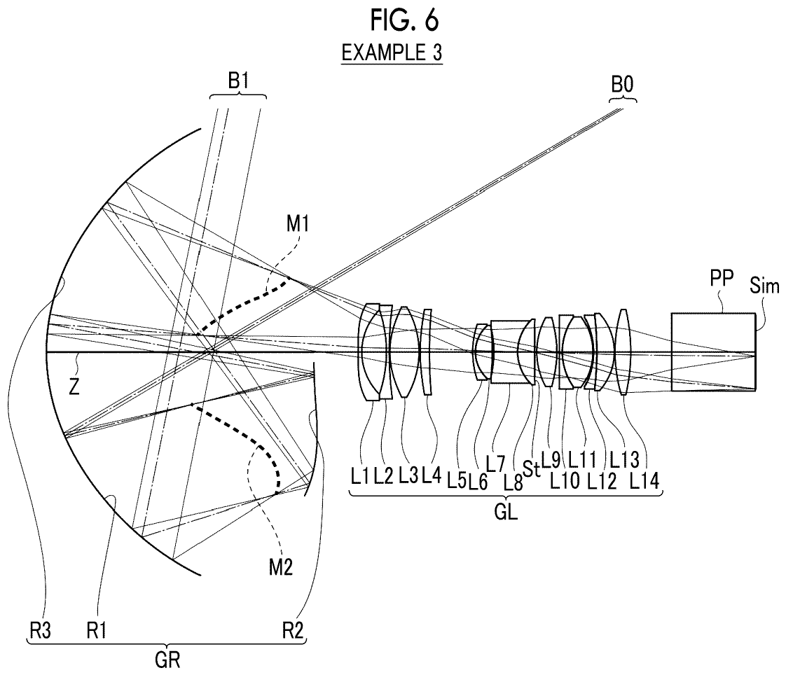

FIG. 6 is a cross-sectional view showing a configuration and luminous fluxes of an imaging optical system according to Example 3. The imaging optical system according to Example 3 consists of a reflective optical system GR and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The first reflecting surface R1 and the third reflecting surface R3 are formed of the same member and have the same surface shape. The refractive optical system GL consists of lenses L1 to L8, an aperture stop St, and lenses L9 to L14 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

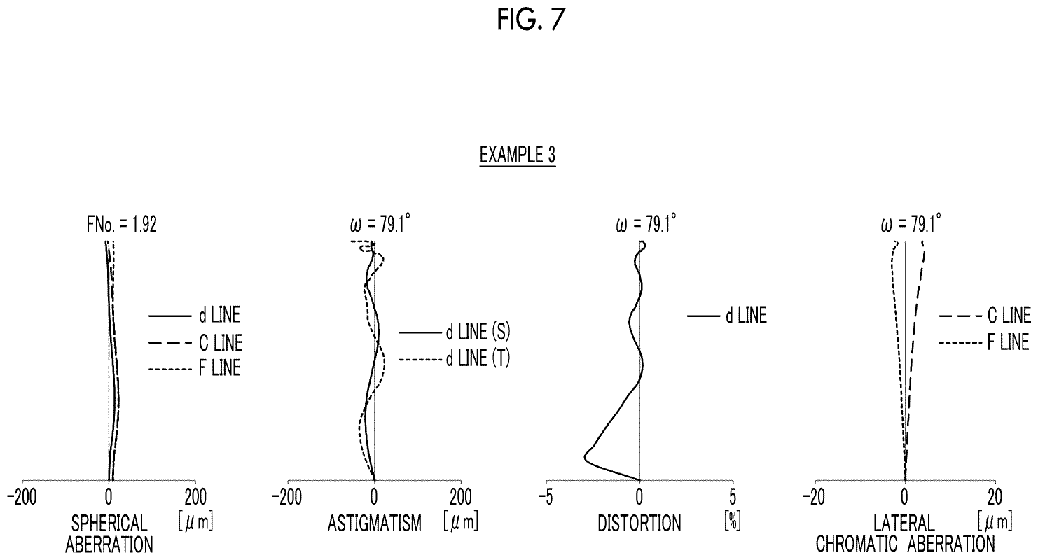

Regarding the imaging optical system according to Example 3. Table 7 shows basic lens data. Table 8 shows specifications. Table 9 shows aspherical coefficients, and FIG. 7 shows each of aberration diagrams in a state where the projection distance is 0.324 meters (m).

TABLE 7
Example 3

| Sn | R | D | Nd | νd | |
|---|---|---|---|---|---|
| *1 | 62.5759 | 78.1800 | | | Reflecting |
| | | | | | Surface |
| *2 | 227.4726 | −78.1800 | | | Reflecting |
| | | | | | Surface |
| *3 | 62.5759 | 91.1864 | | | Reflecting |
| | | | | | Surface |
| *4 | ∞ | 1.0400 | 1.72916 | 54.68 | |
| 5 | 18.6285 | 7.2166 | | | |
| 6 | −41.7154 | 0.8100 | 1.92286 | 20.88 | |
| 7 | 111.2286 | 0.2000 | | | |
| *8 | 25.5205 | 8.5400 | 1.51742 | 52.43 | |
| 9 | −27.9500 | 0.3400 | | | |
| *10 | 56.7987 | 2.7100 | 1.80518 | 25.46 | |
| 11 | 158.5181 | 12.6619 | | | |
| 12 | 27.4224 | 0.8000 | 1.90043 | 37.37 | |
| 13 | 11.1730 | 4.9500 | 1.67270 | 32.10 | |
| 14 | −75.7140 | 0.4682 | | | |
| 15 | −34.0677 | 6.9600 | 1.90043 | 37.37 | |
| 16 | 14.0954 | 4.9100 | 1.80809 | 22.76 | |
| 17 | 406.7297 | 0.1200 | | | |
| 18(St) | ∞ | 0.5800 | | | |
| 10 | 22.6285 | 5.8800 | 1.51742 | 52.43 | |
| *20 | −30.5443 | 0.6900 | | | |
| 21 | ∞ | 0.9000 | 1.95375 | 32.32 | |
| 22 | 18.8698 | 8.8300 | 1.48749 | 70.44 | |
| 23 | −18.8698 | 0.2000 | | | |
| 24 | −23.0909 | 0.9300 | 2.00069 | 25.46 | |
| 25 | −101.7220 | 5.1400 | 1.48749 | 70.44 | |
| 26 | −18.1195 | 0.2000 | | | |
| 27 | 47.2808 | 4.6000 | 1.60311 | 60.64 | |
| 28 | −59.5384 | 12.0000 | | | |
| 29 | ∞ | 24.5000 | 1.51680 | 64.20 | |
| 30 | ∞ | 0.2009 | | | |

TABLE 8
Example 3

| | |
|---|---|
| f | 2.12 |
| Bf | 28.34 |
| FNo. | 1.92 |
| 2ω[°] | 158.2 |

TABLE 9
Example 3

| Sn | 1 | 2 | 3 |
|---|---|---|---|
| KA | 4.9484650E−01 | 2.1016143E+01 | 4.9484650E−01 |
| A3 | 2.0670685E−05 | 1.7408582E−04 | 2.0670685E−05 |
| A4 | −3.3224988E−06 | −7.1080471E−05 | −3.3224988E−06 |
| A5 | 1.7181164E−07 | 8.1664560E−06 | 1.7181164E−07 |
| A6 | 1.3803767E−09 | −2.3589031E−07 | 1.3803767E−09 |
| A7 | −4.0534139E−10 | −1.4905223E−08 | −4.0534139E−10 |
| A8 | 9.2215574E−12 | 9.2981646E−10 | 9.2215574E−12 |
| A9 | 2.0375333E−13 | 6.2385263E−12 | 2.0375333E−13 |
| A10 | −1.0060937E−14 | −1.3352700E−12 | −1.0060937E−14 |
| A11 | 1.6697234E−17 | 8.6845273E−15 | 1.6697234E−17 |
| A12 | 4.3017226E−18 | 1.1360941E−15 | 4.3017226E−18 |
| A13 | −4.5208445E−20 | −1.5481642E−17 | −4.5208445E−20 |
| A14 | −8.4810951E−22 | −6.3250099E−19 | −8.4810951E−22 |
| A15 | 1.5641416E−23 | 1.2890556E−20 | 1.5641416E−23 |
| A16 | 5.2893627E−26 | 1.8957439E−22 | 5.2893627E−26 |
| A17 | −2.3072995E−27 | −5.9555061E−24 | −2.3072995E−27 |
| A18 | 5.6058850E−30 | −4.4733331E−27 | 5.6058850E−30 |
| A19 | 1.2937950E−31 | 1.1394564E−27 | 1.2937950E−31 |
| A20 | −7.1642091E−34 | −8.2026634E−30 | −7.1642091E−34 |

| Sn | 4 | 8 | 10 | 20 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 1.1890529E−04 | −5.3626389E−05 | −1.4081630E−05 | 3.9779385E−05 |
| A5 | −8.8687390E−06 | 9.3189604E−06 | 4.2814060E−06 | −8.5327356E−07 |
| A6 | 1.6137207E−07 | −6.3984935E−07 | −1.0094215E−06 | 7.6658191E−08 |
| A7 | 3.6831937E−08 | −1.4050469E−08 | 9.0958580E−08 | −4.8679958E−09 |
| A8 | −2.1602541E−09 | 3.3884215E−09 | −1.0583872E−09 | −2.9616178E−10 |
| A9 | −2.7392546E−11 | −1.0920277E−10 | −3.0223454E−10 | 8.5785377E−12 |
| A10 | 3.0791861E−12 | −1.0565732E−13 | 1.3070503E−11 | 4.0225722E−13 |

### Example 4

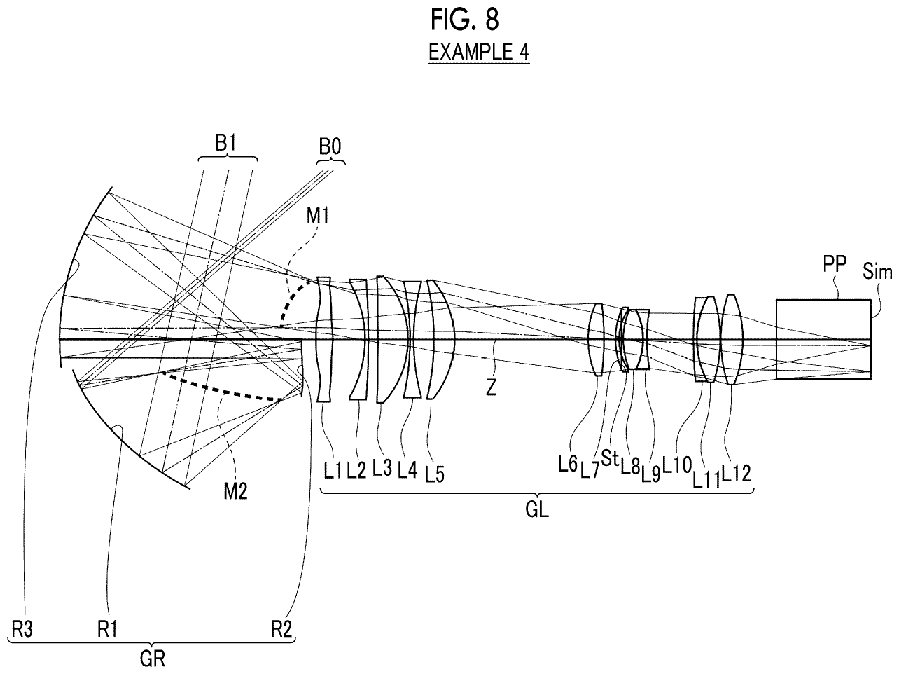

FIG. 8 is a cross-sectional view showing a configuration and luminous fluxes of an imaging optical system according to Example 4. The imaging optical system according to Example 4 consists of a reflective optical system GR and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The refractive optical system GL consists of lenses L1 to L7, an aperture stop St, and lenses L8 to L12. A first intermediate image M1 is formed on the optical path between the refractive optical system GL and the third reflecting surface R3. A second intermediate image M2 is formed on the optical path between the second reflecting surface R2 and the first reflecting surface R1.

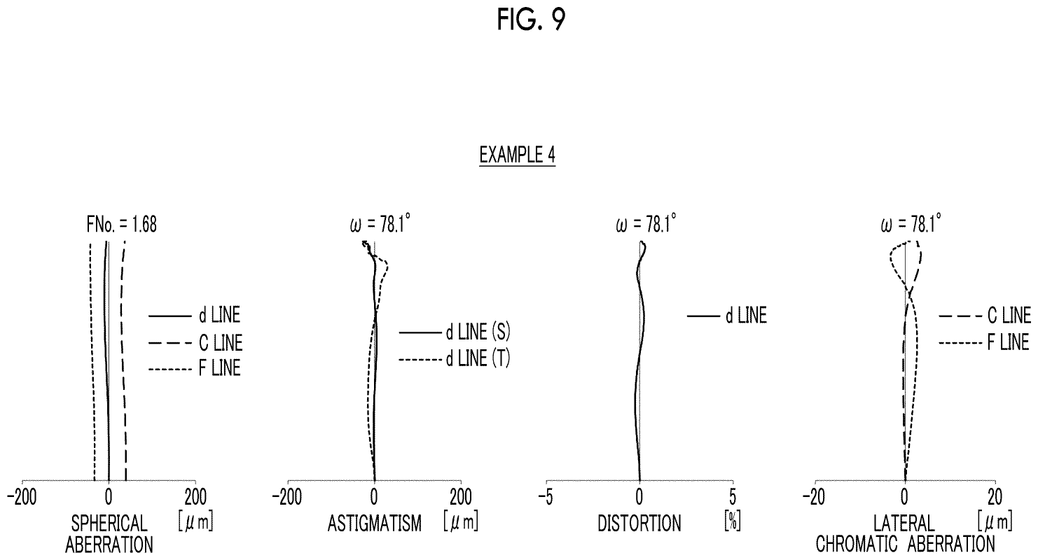

Regarding the imaging optical system according to Example 4. Table 10 shows basic lens data. Table 11 shows specifications. Table 12 shows aspherical coefficients, and FIG. 9 shows each of aberration diagrams in a state where the projection distance is 0.430 meters (m).

TABLE 10
Example 4

| Sn | R | D | Nd | νd | |
|---|---|---|---|---|---|
| *1 | 32.0680 | 79.7500 | | | Reflecting |
| | | | | | Surface |
| *2 | 80.6818 | −82.4741 | | | Reflecting |
| | | | | | Surface |
| *3 | 88.6891 | 87.4742 | | | Reflecting |
| | | | | | Surface |
| *4 | −403.0262 | 5.7045 | 1.51007 | 56.24 | |
| *5 | −25.5927 | 10.9735 | | | |
| 6 | −42.1526 | 1.2000 | 1.60738 | 56.82 | |
| 7 | −289.1760 | 3.2086 | | | |
| 8 | −925.8158 | 10.2775 | 1.51742 | 52.43 | |
| 9 | −33.9505 | 0.6883 | | | |
| 10 | −98.2644 | 1.2004 | 1.80400 | 46.53 | |
| 11 | 80.3752 | 6.9581 | | | |
| 12 | −91.8902 | 6.8783 | 1.65844 | 50.88 | |
| 13 | −34.0606 | 45.4956 | | | |
| 14 | 32.2189 | 5.4094 | 1.48749 | 70.44 | |
| 15 | −105.2785 | 5.9301 | | | |
| 16(St) | ∞ | −2.0098 | | | |
| 17 | 27.8787 | 1.2006 | 1.80400 | 46.53 | |
| 18 | 18.8050 | 1.4514 | | | |
| 19 | 27.2323 | 6.6969 | 1.51742 | 52.43 | |
| 20 | −24.1411 | 0.1207 | | | |
| 21 | −23.4680 | 1.2007 | 1.80440 | 39.58 | |
| 22 | 57.7071 | 15.9036 | | | |
| 23 | 153.4166 | 1.2009 | 1.79952 | 42.24 | |
| 24 | 32.2895 | 7.9675 | 1.58913 | 61.13 | |
| 25 | −51.7150 | 0.2000 | | | |
| 26 | 52.3743 | 7.4921 | 1.53775 | 74.70 | |
| 27 | −43.0537 | 11.5000 | | | |
| 28 | ∞ | 32.1500 | 1.51680 | 64.20 | |
| 29 | ∞ | 0.1596 | | | |

TABLE 11
Example 4

| | |
|---|---|
| f | 2.53 |
| Bf | 32.84 |
| FNo. | 1.68 |
| 2ω[°] | 156.2 |

TABLE 12
Example 4

| Sn | 1 | 2 | 3 |
|---|---|---|---|
| KA | 2.7440972E−01 | 8.0209624E+00 | −1.0828293E+00 |
| A3 | 0.0000000E+00 | 0.0000000E+00 | 0.0000000E+00 |
| A4 | −1.5727758E−06 | −6.7444778E−05 | 2.8107038E−07 |
| A5 | −1.5475182E−07 | 6.1020501E−06 | 1.1521027E−08 |
| A6 | 7.0219118E−09 | 2.5265943E−08 | −1.0007724E−09 |
| A7 | −1.2329329E−11 | −3.9549098E−08 | 3.8248985E−11 |
| A8 | −5.7046655E−12 | 1.5376586E−09 | −4.8599481E−13 |
| A9 | 1.0247085E−13 | 8.6071456E−11 | −1.0659642E−14 |
| A10 | 1.3991962E−15 | −7.5624153E−12 | 3.9922946E−16 |
| A11 | −5.3804736E−17 | 8.3059010E−14 | −2.0046954E−18 |
| A12 | 1.4802709E−19 | 9.8785387E−15 | −7.9573484E−20 |
| A13 | 8.3939391E−21 | −4.3651349E−16 | 1.3430506E−21 |
| A14 | −7.3107825E−23 | 5.8950622E−18 | −6.4363051E−24 |

| Sn | 4 | 5 |
|---|---|---|
| KA | −1.0000000E+01 | −1.0000000E+01 |
| A3 | 0.0000000E+00 | 0.0000000E+00 |
| A4 | 3.9829966E−04 | 3.1878299E−04 |
| A5 | −4.1819476E−05 | −2.0498026E−05 |
| A6 | 2.1584398E−07 | −1.4788913E−06 |
| A7 | 1.9612557E−07 | 1.5862761E−07 |
| A8 | −1.0765950E−08 | 1.7232633E−09 |
| A9 | −1.9338022E−10 | −6.0910377E−10 |
| A10 | 2.9293499E−11 | 9.2284534E−12 |
| A11 | −1.5586060E−13 | 1.1122429E−12 |
| A12 | −3.4968563E−14 | −3.0281862E−14 |
| A13 | 6.2335940E−16 | −7.7271077E−16 |
| A14 | 3.2155229E−18 | 2.5797054E−17 |

### Example 5

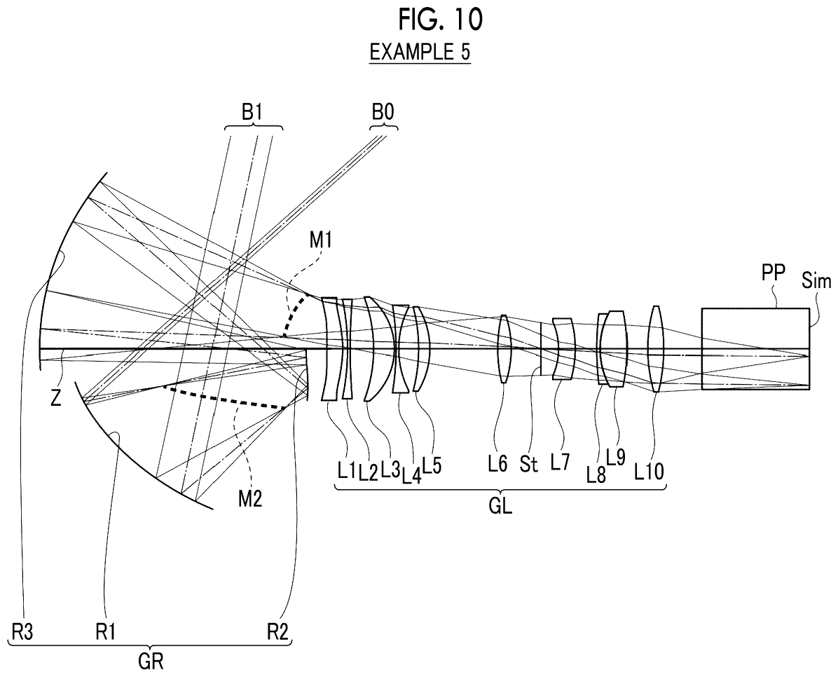

FIG. 10 is a cross-sectional view showing a configuration and luminous fluxes of an imaging optical system according to Example 5. The imaging optical system according to Example 5 consists of a reflective optical system GR and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The refractive optical system GL consists of lenses L1 to L6, an aperture stop St, and lenses L7 to L10 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

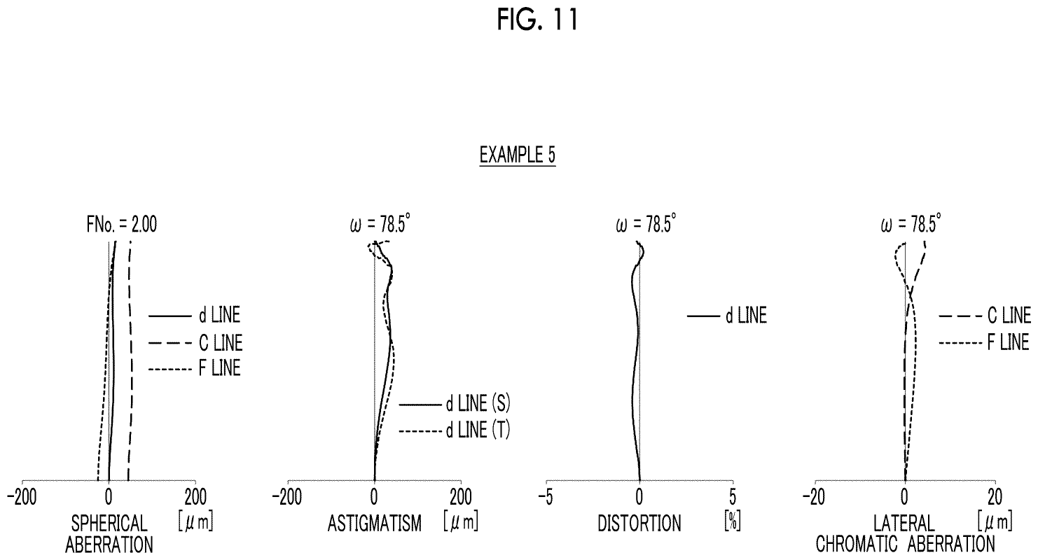

Regarding the imaging optical system according to Example 5. Table 13 shows basic lens data. Table 14 shows specifications. Table 15 shows aspherical coefficients, and FIG. 11 shows each of aberration diagrams in a state where the projection distance is 0.420 meters (m).

TABLE 13
Example 5

| Sn | R | D | Nd | νd | |
|---|---|---|---|---|---|
| *1 | 30.4812 | 70.7387 | | | Reflecting |
| | | | | | Surface |
| *2 | 48.4265 | −79.6216 | | | Reflecting |
| | | | | | Surface |
| *3 | 83.8923 | 85.8471 | | | Reflecting |
| | | | | | Surface |
| *4 | −546.4647 | 4.7405 | 1.69350 | 53.18 | |
| *5 | −27.7956 | 1.4568 | | | |
| 6 | −78.9304 | 0.7991 | 1.80420 | 46.50 | |
| 7 | 207.6844 | 7.0037 | | | |
| 8 | −47.1098 | 6.2179 | 1.51680 | 64.20 | |
| 9 | −21.3093 | 0.5002 | | | |
| 10 | −87.0278 | 0.7993 | 1.59282 | 68.62 | |
| 11 | 29.5327 | 5.9688 | | | |
| 12 | −52.7749 | 3.3602 | 1.58144 | 40.75 | |
| 13 | −26.3108 | 20.3423 | | | |
| 14 | 47.3228 | 4.0156 | 1.48749 | 70.44 | |
| 15 | −34.0638 | 8.8598 | | | |
| 16(St) | ∞ | 5.3255 | | | |
| 17 | −21.1236 | 5.0009 | 1.84666 | 23.78 | |
| 18 | −35.3511 | 6.4395 | | | |
| 19 | 98.2978 | 0.9991 | 1.85883 | 30.00 | |
| 20 | 25.3168 | 8.0109 | 1.51680 | 64.20 | |
| 21 | −60.6909 | 6.1097 | | | |
| 22 | 49.0960 | 4.7680 | 1.72916 | 54.54 | |
| 23 | −57.7818 | 11.5000 | | | |
| 24 | ∞ | 32.1500 | 1.51680 | 64.20 | |
| 25 | ∞ | 0.0672 | | | |

TABLE 14
Example 5

| | |
|---|---|
| f | 2.45 |
| Bf | 32.75 |
| FNo. | 2.00 |
| 2ω[°] | 157.0 |

TABLE 15
Example 5

| Sn | 1 | 2 | 3 |
|---|---|---|---|
| KA | 2.7339926E−01 | 7.0006973E+00 | −1.0732261E+00 |
| A3 | 0.0000000E+00 | 0.0000000E+00 | 0.0000000E+00 |
| A4 | −1.3067317E−06 | −1.2880287E−04 | 3.3921252E−07 |
| A5 | −2.0168222E−07 | 9.0534137E−06 | 1.4240057E−08 |
| A6 | 9.5448812E−09 | 1.8919742E−07 | −1.1292937E−09 |
| A7 | 5.9465575E−13 | −7.0503596E−08 | 3.9217112E−11 |
| A8 | −9.4450674E−12 | 2.0463625E−09 | −3.9715445E−13 |
| A9 | 1.6396040E−13 | 1.9894484E−10 | −1.2538411E−14 |
| A10 | 2.9260519E−15 | −1.1792621E−11 | 3.8084391E−16 |
| A11 | −1.0370820E−16 | −5.2052917E−14 | −1.1985236E−18 |
| A12 | 1.9536620E−19 | 1.5934296E−14 | −8.3079980E−20 |
| A13 | 1.9001599E−20 | −5.3180827E−16 | 1.2660384E−21 |
| A14 | −1.6376812E−22 | 1.1254020E−17 | −5.7832247E−24 |

| Sn | 4 | 5 |
|---|---|---|
| KA | 9.8742821E+02 | −9.5476211E+00 |
| A3 | 0.0000000E+00 | 0.0000000E+00 |
| A4 | 1.3937035E−04 | 2.5334012E−04 |
| A5 | −2.9666999E−05 | −3.0428039E−05 |
| A6 | 9.0087541E−07 | −1.2881399E−06 |
| A7 | 9.6364873E−08 | 3.2581464E−07 |
| A8 | −8.1503157E−09 | −3.3044434E−09 |
| A9 | 2.3010452E−10 | −1.6721216E−09 |
| A10 | 1.2735165E−11 | 6.5665934E−11 |
| A11 | −9.9472605E−13 | 4.0253879E−12 |
| A12 | −1.0467168E−14 | −2.3228991E−13 |
| A13 | 1.3220043E−15 | −3.6683190E−15 |
| A14 | −8.3377130E−18 | 2.5850161E−16 |

### Example 6

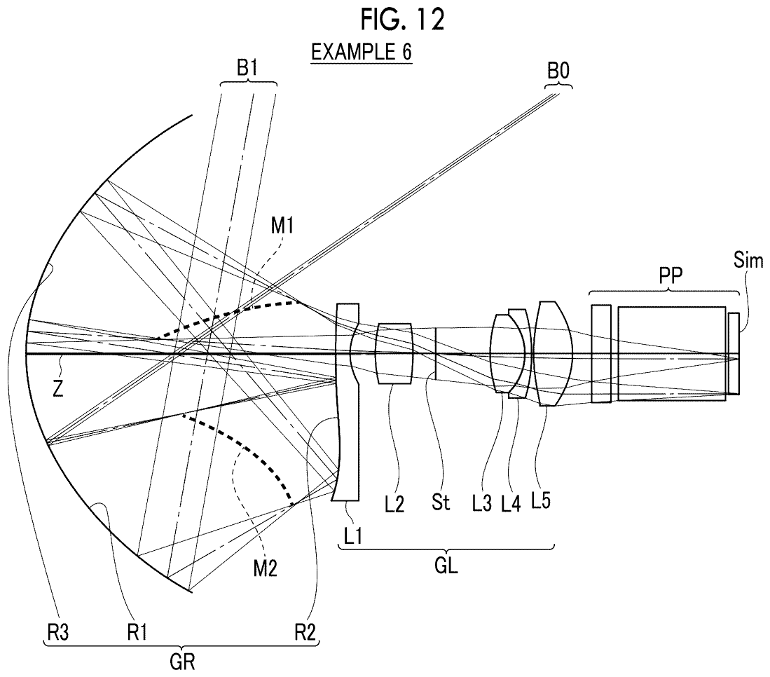

FIG. 12 is a cross-sectional view showing a configuration and luminous fluxes of an imaging optical system according to Example 6. The imaging optical system according to Example 6 consists of a reflective optical system GR and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The first reflecting surface R1 and the third reflecting surface R3 are formed of the same member and have the same surface shape. The refractive optical system GL consists of lenses L1 and L2, an aperture stop St, and lenses L3 to L5 in order from the enlargement side to the reduction side. The second reflecting surface R2 is formed on a surface of the lens L1 on the enlargement side. A first intermediate image M1 is formed on the optical path between the refractive optical system GL and the third reflecting surface R3. A second intermediate image M2 is formed on the optical path between the second reflecting surface R2 and the first reflecting surface R1.

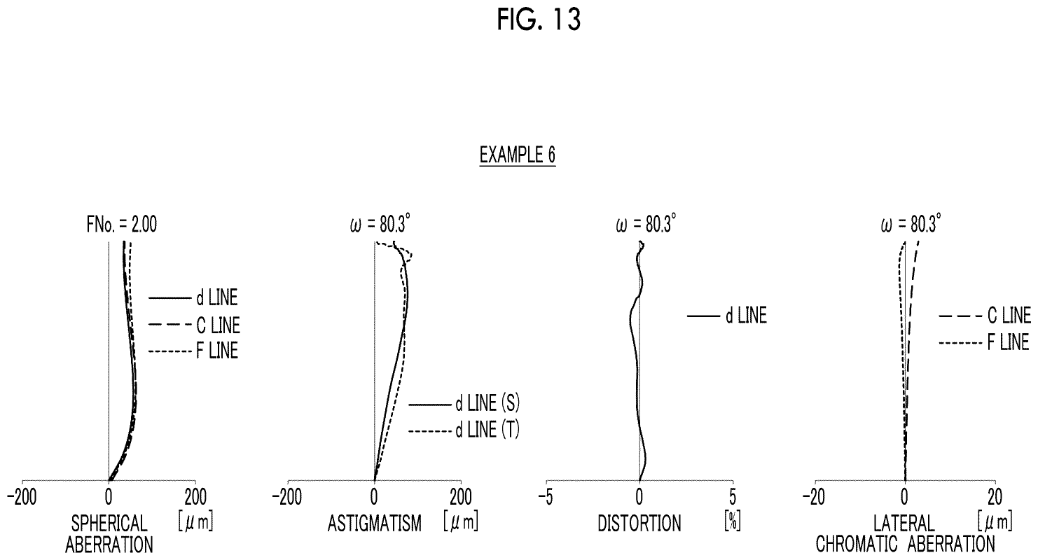

Regarding the imaging optical system according to Example 6, Table 16 shows basic lens data, Table 17 shows specifications, Table 18 shows aspherical coefficients, and FIG. 13 shows each of aberration diagrams in a state where the projection distance is 0.177 meters (m).

TABLE 16
Example 6

| Sn | R | D | Nd | νd | |
|---|---|---|---|---|---|
| *1 | 21.5653 | 32.3588 | | | Reflecting |
| | | | | | Surface |
| *2 | 93.6333 | −32.3588 | | | Reflecting |
| | | | | | Surface |
| *3 | 21.5653 | 32.3588 | | | Reflecting |
| | | | | | Surface |
| *4 | 93.6333 | 1.5007 | 1.53634 | 56.14 | |
| *5 | 5.6041 | 2.6423 | | | |
| 6 | 14.2674 | 3.8791 | 1.60342 | 38.03 | |
| 7 | −21.9465 | 2.3708 | | | |
| 8(St) | ∞ | 5.6946 | | | |
| 9 | 14.0765 | 3.6392 | 1.49700 | 81.61 | |
| 10 | −6.0606 | 0.7024 | 1.91082 | 35.25 | |
| 11 | −17.7331 | 0.1992 | | | |
| *12 | 17.9967 | 4.0699 | 1.51633 | 64.06 | |
| *13 | −9.1917 | 2.0000 | | | |
| 14 | ∞ | 2.0000 | 1.51680 | 64.20 | |
| 15 | ∞ | 0.8000 | | | |
| 16 | ∞ | 11.2000 | 1.72342 | 37.95 | |
| 17 | ∞ | 0.3000 | | | |
| 18 | ∞ | 1.1000 | 1.48749 | 70.44 | |
| 19 | ∞ | 0.0208 | | | |

TABLE 17
Example 6

| | |
|---|---|
| f | 0.76 |
| Bf | 11.67 |
| FNo. | 2.00 |
| 2ω[°] | 160.6 |

TABLE 18
Example 6

| Sn | 1 | 2 | 3 | 4 |
|---|---|---|---|---|
| KA | 3.8499608E−01 | 1.0000000E+01 | 3.8499608E−01 | 1.0000000E+01 |
| A3 | 2.1208292E−05 | −5.9687222E−04 | 2.1208292E−05 | −5.9687222E−04 |
| A4 | 7.3303171E−06 | 1.2054461E−04 | 7.3303171E−06 | 1.2054461E−04 |
| A5 | −2.6502831E−06 | 2.4101884E−05 | −2.6502831E−06 | 2.4101884E−05 |
| A6 | 1.1960185E−07 | −6.2051115E−06 | 1.1960185E−07 | −6.2051115E−06 |
| A7 | 4.7591481E−09 | 1.3977765E−07 | 4.7591481E−09 | 1.3977765E−07 |
| A8 | −4.0203927E−10 | 4.0371469E−08 | −4.0203927E−10 | 4.0371469E−08 |
| A9 | −5.2387376E−12 | −2.2164248E−09 | −5.2387376E−12 | −2.2164248E−09 |
| A10 | 7.3683148E−13 | −9.4305783E−11 | 7.3683148E−13 | −9.4305783E−11 |
| A11 | 6.1373025E−15 | 8.6827823E−12 | 6.1373025E−15 | 8.6827823E−12 |
| A12 | −9.5665516E−16 | 3.0347889E−14 | −9.5665516E−16 | 3.0347889E−14 |
| A13 | −4.4362296E−18 | −1.4180874E−14 | −4.4362296E−18 | −1.4180874E−14 |
| A14 | 7.3183382E−19 | 1.7700406E−16 | 7.3183382E−19 | 1.7700406E−16 |
| A15 | 1.1519646E−21 | 8.3815039E−18 | 1.1519646E−21 | 8.3815039E−18 |
| A16 | −2.2703009E−22 | −1.7985201E−19 | −2.2703009E−22 | −1.7985201E−19 |

| Sn | 5 | 12 | 13 |
|---|---|---|---|
| KA | 1.5089094E+00 | 1.0000000E+00 | 1.0000000E+00 |
| A3 | 2.7994650E−03 | 0.0000000E+00 | 0.0000000E+00 |
| A4 | −4.1652828E−03 | −2.2711686E−04 | −1.0673530E−04 |
| A5 | 7.2262397E−04 | 2.9674407E−06 | 8.6277550E−05 |
| A6 | −5.2618480E−05 | 7.6416156E−06 | −1.3656159E−05 |
| A7 | −1.4033736E−05 | −2.6274170E−06 | −1.4193737E−07 |
| A8 | −7.2513347E−07 | 1.7641196E−07 | 2.0549054E−07 |
| A9 | 1.1655384E−07 | 3.3317461E−08 | 4.2835340E−10 |
| A10 | 1.6118100E−08 | −3.2234705E−09 | −9.5743152E−10 |
| A11 | −4.7872127E−10 | | |
| A12 | −1.0614117E−10 | | |
| A13 | 9.1529640E−13 | | |
| A14 | 3.0783317E−13 | | |
| A15 | −5.9260165E−16 | | |
| A16 | −3.4343478E−16 | | |

### Example 7

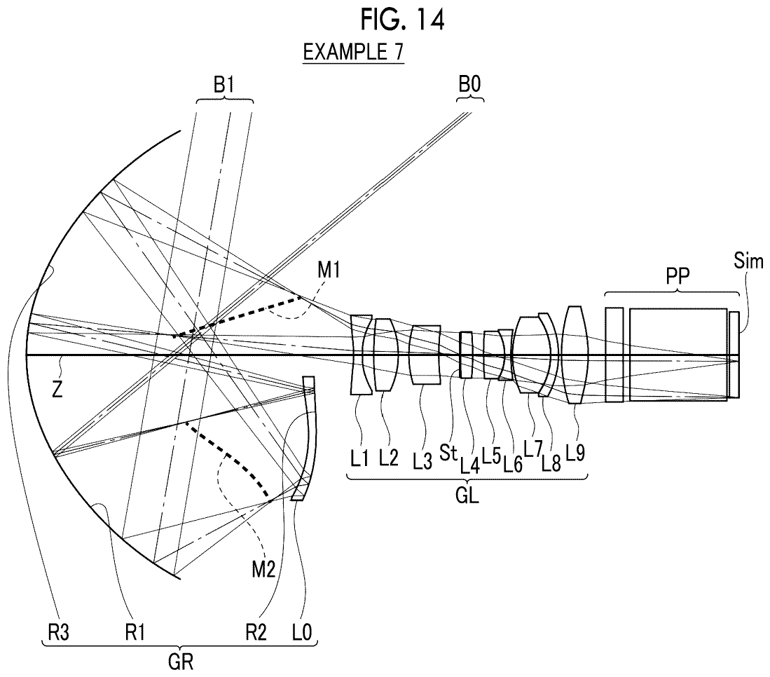

FIG. 14 is a cross-sectional view showing a configuration and luminous fluxes of an imaging optical system according to Example 7. The imaging optical system according to Example 7 consists of a reflective optical system GR and a refractive optical system GL along the optical path in order from the enlargement side to the reduction side. The reflective optical system GR consists of a first reflecting surface R1 having a positive power, a lens L0, and a third reflecting surface R3 having a positive power along the optical path in order from the enlargement side to the reduction side. The first reflecting surface R1 and the third reflecting surface R3 are formed of the same member and have the same surface shape. A second reflecting surface R2 having a power is formed on a surface of the lens L0 on the refractive optical system side (the right side in FIG. 14). A luminous flux that is reflected from the third reflecting surface R3 and travels toward the enlargement side transmits through the inside of the lens L0, is reflected from the second reflecting surface R2, transmits through the inside of the lens L0 again, and is incident into the first reflecting surface R1. The refractive optical system GL consists of lenses L1 to L3, an aperture stop St, and lenses L4 to L9 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

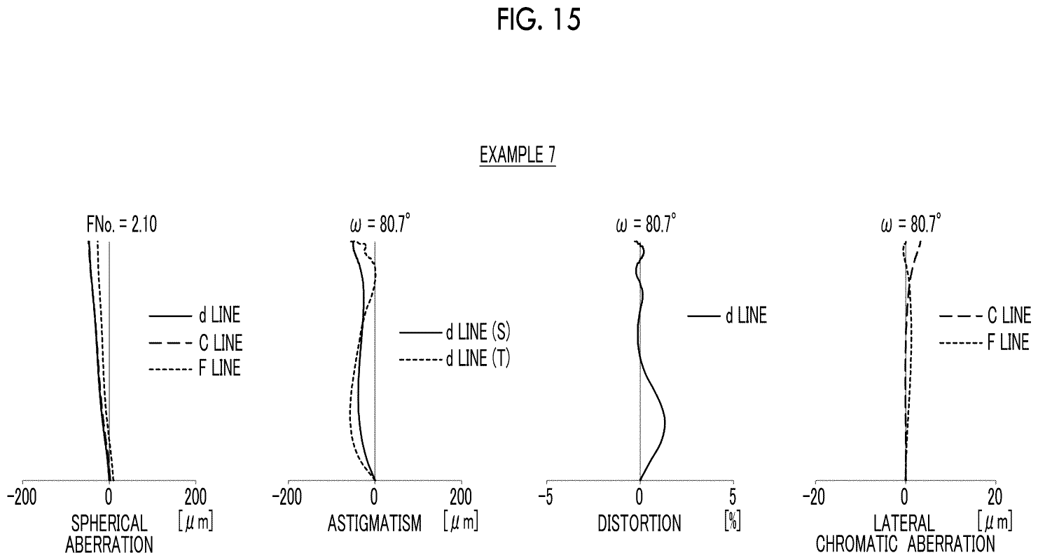

Regarding the imaging optical system according to Example 7, Table 19 shows basic lens data, Table 20 shows specifications, Table 21 shows aspherical coefficients, and FIG. 15 shows each of aberration diagrams in a state where the projection distance is 0.200 meters (m).

TABLE 19
Example 7

| Sn | R | D | Nd | νd | |
|---|---|---|---|---|---|
| *1 | 22.9738 | 31.8995 | | | Reflecting |
| | | | | | Surface |
| *2 | 222.0429 | 1.3408 | 1.51633 | 64.14 | |
| *3 | 363.6331 | −1.3408 | 1.51633 | 64.14 | Reflecting |
| | | | | | Surface |
| *4 | 222.0429 | −31.8995 | | | |
| *5 | 22.9738 | 37.8500 | | | Reflecting |
| | | | | | Surface |
| *6 | −8.6960 | 1.0002 | 1.75501 | 51.16 | |
| *7 | 15.0601 | 1.3186 | | | |
| 8 | 34.2654 | 2.7809 | 1.51633 | 64.14 | |
| 9 | −10.1424 | 1.2185 | | | |
| 10 | 12.4780 | 3.4512 | 1.84666 | 23.78 | |
| 11 | 25.0200 | 2.4297 | | | |
| 12(St) | ∞ | 0.1001 | | | |
| 13 | 69.9326 | 1.4010 | 1.58144 | 40.75 | |
| 14 | −28.9643 | 1.2531 | | | |
| 15 | 36.9683 | 2.4593 | 1.49700 | 81.61 | |
| 16 | −5.8040 | 0.7002 | 1.90043 | 37.37 | |
| 17 | 19.9976 | 0.2003 | | | |
| 18 | 11.5952 | 4.4042 | 1.49700 | 81.61 | |
| 19 | −8.0966 | 0.9036 | 1.90043 | 37.37 | |
| 20 | −10.4482 | 0.3458 | | | |
| 21 | 20.0476 | 3.0873 | 1.69560 | 59.05 | |
| *22 | −16.4060 | 2.0336 | | | |
| 23 | ∞ | 2.0000 | 1.51680 | 64.20 | |
| 24 | ∞ | 0.8000 | | | |
| 25 | ∞ | 11.2000 | 1.72342 | 37.95 | |
| 26 | ∞ | 0.3000 | | | |
| 27 | ∞ | 1.1000 | 1.48749 | 70.44 | |
| 28 | ∞ | 0.0414 | | | |

TABLE 20
Example 7

| | |
|---|---|
| f | 0.86 |
| Bf | 11.73 |
| FNo. | 2.10 |
| 2ω[°] | 161.4 |

TABLE 21
Example 7

| Sn | 1 | 2 | 3 | 4 |
|---|---|---|---|---|
| KA | 2.8278208E−01 | −1.5919044E+01 | −2.3022095E+00 | −1.5919044E+01 |
| A3 | 1.4807978E−04 | 3.1434378E−03 | 2.5682121E−04 | 3.1434378E−03 |
| A4 | −2.3883824E−05 | 1.0269749E−04 | 2.7742328E−04 | 1.0269749E−04 |
| A5 | −3.6476824E−07 | −9.1501293E−05 | −4.6620415E−05 | −9.1501293E−05 |
| A6 | 2.9272872E−07 | 2.3206602E−06 | −1.3127526E−06 | 2.3206602E−06 |
| A7 | −2.4403289E−08 | 9.4673066E−07 | 6.3958387E−07 | 9.4673066E−07 |
| A8 | 2.8563296E−10 | −6.0053783E−08 | −2.5799301E−08 | −6.0053783E−08 |
| A9 | 6.8880926E−11 | −3.6491413E−09 | −2.7669747E−09 | −3.6491413E−09 |
| A10 | −3.5075079E−12 | 3.9791770E−10 | 2.3611796E−10 | 3.9791770E−10 |
| A11 | −1.4857096E−14 | 1.4404383E−12 | 1.3900956E−12 | 1.4404383E−12 |
| A12 | 5.3459960E−15 | −1.0446111E−12 | −6.6140658E−13 | −1.0446111E−12 |
| A13 | −1.1026236E−16 | 1.9988556E−14 | 1.5415038E−14 | 1.9988556E−14 |
| A14 | −1.7073910E−18 | 8.9596052E−16 | 5.0446216E−16 | 8.9596052E−16 |
| A15 | 8.6198793E−20 | −3.1390648E−17 | −2.5058858E−17 | −3.1390648E−17 |
| A16 | −8.4926488E−22 | 1.9260907E−19 | 2.7570395E−19 | 1.9260907E−19 |
| Sn | 5 | 6 | 7 | 22 |
| KA | 2.8278208E−01 | 1.0000000E+00 | 1.0000000E+00 | 1.0000000E+00 |
| A3 | 1.4807978E−04 | 0.0000000E+00 | 0.0000000E+00 | 0.0000000E+00 |
| A4 | −2.3883824E−05 | 9.7167146E−03 | 7.4226475E−03 | 2.9564143E−05 |
| A5 | −3.6476824E−07 | −6.0520016E−04 | 1.7360822E−04 | 6.7473628E−05 |
| A6 | 2.9272872E−07 | −1.6378391E−03 | −1.5941005E−03 | −1.6612217E−05 |
| A7 | −2.4403289E−08 | 5.8689580E−04 | 3.5056187E−04 | 2.2450306E−07 |
| A8 | 2.8563296E−10 | −5.1280297E−05 | 4.8485290E−05 | 5.9129608E−07 |
| A9 | 6.8880926E−11 | −1.0449378E−05 | −2.3252522E−05 | −4.0979099E−08 |
| A10 | −3.5075079E−12 | 2.5366100E−06 | 9.3910065E−07 | −8.7030334E−09 |
| A11 | −1.4857096E−14 | −1.6003095E−07 | 4.0903031E−07 | 5.8278452E−10 |
| A12 | 5.3459960E−15 | 1.1111366E−09 | −3.9570047E−08 | 5.6675737E−11 |
| A13 | −1.1026236E−16 | | | |
| A14 | −1.7073910E−18 | | | |
| A15 | 8.6198793E−20 | | | |
| A16 | −8.4926488E−22 | | | |

### Example 8

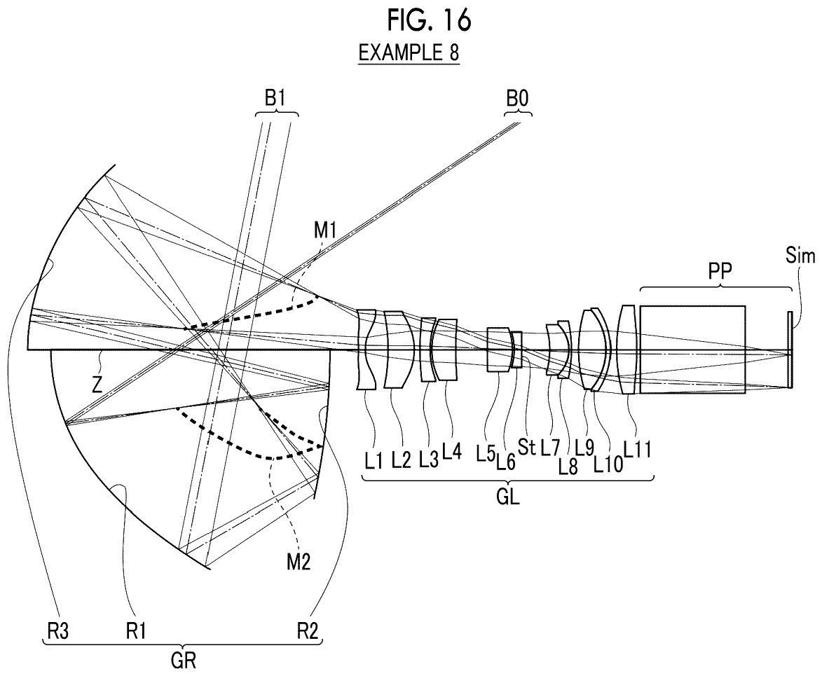

FIG. 16 is a cross-sectional view showing a configuration and luminous fluxes of an imaging optical system according to Example 8. The imaging optical system according to Example 8 consists of a reflective optical system GR and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The refractive optical system GL consists of lenses L1 to L6, an aperture stop St, and lenses L7 to L11 in order from the enlargement side to the reduction side. A first intermediate image M1 is formed on the optical path between the refractive optical system GL and the third reflecting surface R3. A part of a second intermediate image M2 is formed on the optical path between the second reflecting surface R2 and the first reflecting surface R1, and the remaining part of the second intermediate image M2 is formed on the optical path between the third reflecting surface R3 and the second reflecting surface R2.

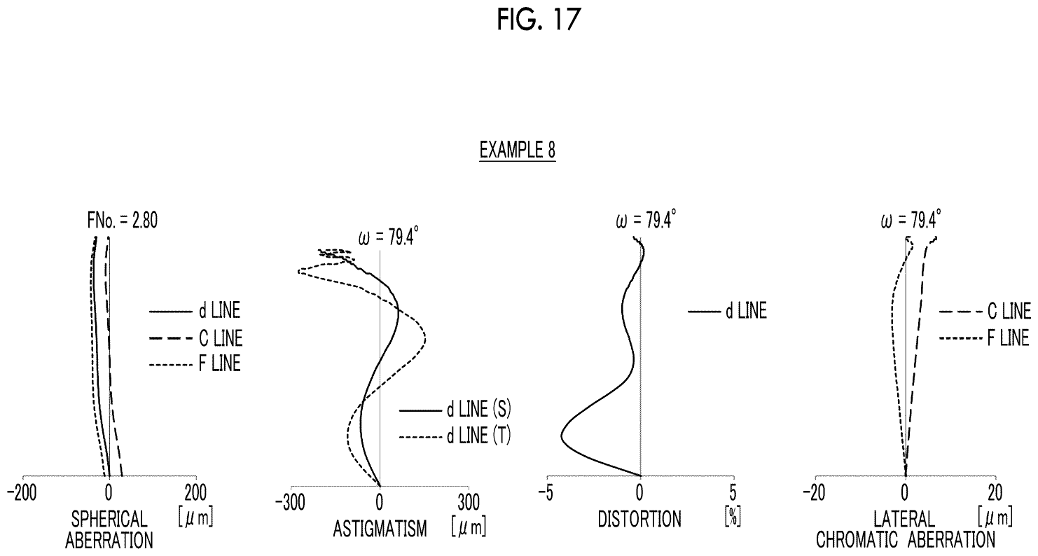

Regarding the imaging optical system according to Example 8, Table 22 shows basic lens data, Table 23 shows specifications, Table 24 shows aspherical coefficients, and FIG. 17 shows each of aberration diagrams in a state where the projection distance is 0.470 meters (m).

TABLE 22
Example 8

| Sn | R | D | Nd | νd | |
|---|---|---|---|---|---|
| *1 | 57.6397 | 79.8730 | | | Reflecting |
| | | | | | Surface |
| 2 | −217.0461 | −86.5125 | | | Reflecting |
| | | | | | Surface |
| *3 | 59.4673 | 94.6698 | | | Reflecting |
| | | | | | Surface |
| *4 | −25.1064 | 1.9998 | 1.75501 | 51.16 | |
| *5 | 25.4665 | 6.4992 | | | |
| 6 | −56.9433 | 7.4996 | 1.58313 | 59.38 | |
| *7 | −18.1818 | 1.6393 | | | |
| 8 | 86.9699 | 2.9000 | 1.67000 | 57.35 | |
| 9 | 26.2540 | 0.5000 | | | |
| 10 | 20.6911 | 6.8485 | 1.61266 | 44.46 | |
| 11 | 117.2748 | 9.0360 | | | |
| 12 | 217.1908 | 7.1991 | 1.72047 | 34.71 | |
| 13 | −18.3620 | 0.5348 | | | |
| 14 | −18.4682 | 2.1377 | 1.83400 | 37.16 | |
| 15 | −271.8169 | 0.0506 | | | |
| 16(St) | ∞ | 8.0000 | | | |
| 17 | −24.4172 | 5.5023 | 1.52855 | 76.97 | |
| 18 | −10.5421 | 0.7006 | 1.70400 | 39.38 | |
| 19 | −42.2458 | 2.0465 | | | |
| 20 | 42.8264 | 7.8642 | 1.49700 | 81.61 | |
| 21 | −18.5775 | 1.2600 | 1.78800 | 47.37 | |
| 22 | −22.9831 | 1.6319 | | | |
| 23 | 50.2678 | 5.8000 | 1.55332 | 71.68 | |
| *24 | −67.5234 | 1.0007 | | | |
| 25 | ∞ | 30.0900 | 1.51680 | 64.20 | |
| 26 | ∞ | 12.2900 | | | |
| 27 | ∞ | 1.0000 | 1.48749 | 70.44 | |
| 28 | ∞ | 0.1712 | | | |

TABLE 23
Example 8

| | |
|---|---|
| f | 2.20 |
| Bf | 33.96 |
| FNo. | 2.80 |
| 2ω[°] | 158.8 |

TABLE 24
Example 8

| Sn | 1 | 3 |
|---|---|---|
| KA | 5.4602903E−01 | 2.2896877E−01 |
| A3 | −4.0245585E−20 | 6.6959942E−05 |
| A4 | 1.5448108E−06 | −8.4153956E−06 |
| A5 | −2.1870407E−07 | 1.9157703E−07 |
| A6 | 6.8726516E−09 | 5.7079015E−09 |
| A7 | 1.0302118E−10 | −3.3155651E−10 |
| A8 | −7.1563553E−12 | 2.5493839E−12 |
| A9 | 2.1786405E−14 | 1.3568789E−13 |
| A10 | 2.8131693E−15 | −2.6679318E−15 |
| A11 | −2.5813630E−17 | −1.4187644E−17 |
| A12 | −5.3025605E−19 | 6.8669746E−19 |
| A13 | 6.8199862E−21 | −1.9408304E−21 |
| A14 | 4.7621967E−23 | −6.2587399E−23 |
| A15 | −7.6549866E−25 | 3.3780963E−25 |
| A16 | −1.6165340E−27 | 1.0257393E−27 |
| A17 | 3.2023496E−29 | |

| Sn | 4 | 5 | 7 | 24 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 2.8759182E−03 | 2.5800353E−03 | −9.3898907E−05 | 3.1540526E−05 |
| A5 | −5.6416044E−04 | −3.6704024E−04 | 4.0059483E−05 | −5.9266298E−06 |
| A6 | 2.1128722E−05 | −2.4284760E−05 | −7.4345854E−06 | 7.2756145E−07 |
| A7 | 4.8091916E−06 | 6.0924428E−06 | 3.6165569E−07 | −1.4652470E−08 |
| A8 | −6.5370381E−07 | −3.6179249E−08 | 7.8834372E−08 | −3.7769986E−09 |
| A9 | 2.0963288E−08 | −3.8037816E−08 | −1.0163964E−08 | 2.8271250E−10 |
| A10 | 1.8853177E−09 | 1.2378540E−09 | 4.3673375E−11 | −3.2008579E−13 |
| A11 | −1.8768688E−10 | 8.0537337E−11 | 4.4403434E−11 | −5.8451054E−13 |
| A12 | 4.8757818E−12 | −3.6772997E−12 | −1.6957787E−12 | 1.6651337E−14 |

### Example 9

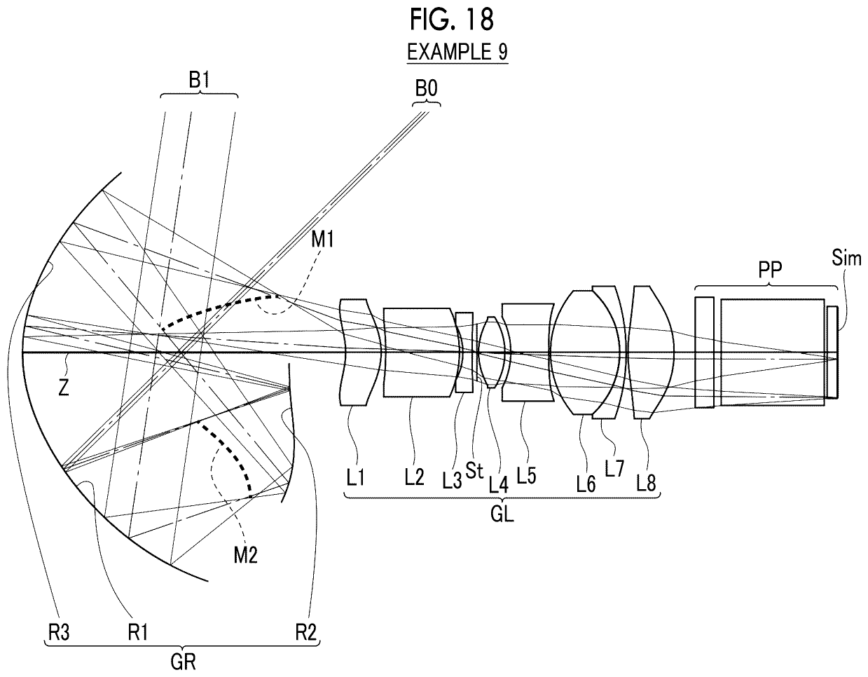

FIG. 18 is a cross-sectional view showing a configuration and luminous fluxes of an imaging optical system according to Example 9. The imaging optical system according to Example 9 consists of a reflective optical system GR and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The first reflecting surface R1 and the third reflecting surface R3 are formed of the same member and have the same surface shape. The refractive optical system GL consists of lenses L1 to L3, an aperture stop St, and lenses L4 to L8 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

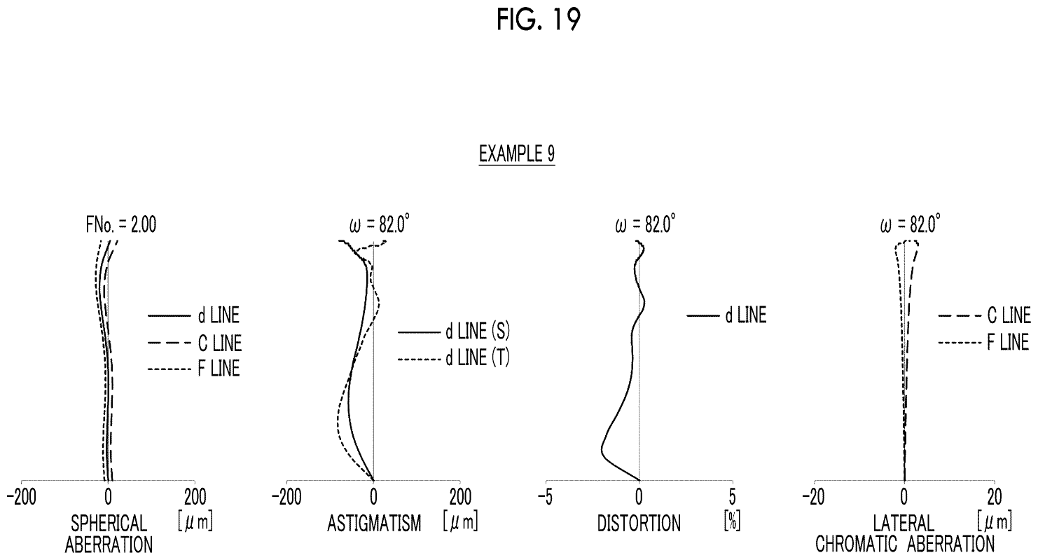

Regarding the imaging optical system according to Example 9, Table 25 shows basic lens data, Table 26 shows specifications, Tables 27A and 27B show aspherical coefficients, and FIG. 19 shows each of aberration diagrams in a state where the projection distance is 0.183 meters (m).

TABLE 25
Example 9

| Sn | R | D | Nd | νd | |
|---|---|---|---|---|---|
| *1 | 19.5105 | 28.9235 | | | Reflecting |
| | | | | | Surface |
| *2 | 101.5702 | 28.9235 | | | Reflecting |
| | | | | | Surface |
| *3 | 19.5105 | 35.0560 | | | Reflecting |
| | | | | | Surface |
| *4 | −8.1922 | 3.8480 | 1.50864 | 56.51 | |
| *5 | −7.6338 | 0.4993 | | | |
| 6 | −30.0622 | 7.9324 | 1.80809 | 22.76 | |
| 7 | −12.4372 | 0.3902 | | | |
| 8 | −6.6230 | 1.0004 | 1.77250 | 49.62 | |
| 9 | 144.2236 | 0.5009 | | | |
| 10(St) | ∞ | 0.1997 | | | |
| *11 | 7.0325 | 2.8462 | 1.51680 | 64.20 | |
| *12 | −7.7094 | 0.6513 | | | |
| 13 | −8.9833 | 4.1092 | 1.77250 | 49.50 | |
| *14 | 57.6312 | 0.1996 | | | |
| 15 | 11.1381 | 7.5040 | 1.49700 | 81.61 | |
| 16 | −9.7614 | 0.6991 | 1.90366 | 31.31 | |
| 17 | −23.2204 | 0.2007 | | | |
| *18 | 16.4924 | 5.0004 | 1.51680 | 64.20 | |
| *19 | −11.9682 | 2.3000 | | | |
| 20 | ∞ | 2.0000 | 1.51680 | 64.20 | |
| 21 | ∞ | 0.8000 | | | |
| 22 | ∞ | 11.2000 | 1.72342 | 37.95 | |
| 23 | ∞ | 0.3000 | | | |
| 24 | ∞ | 1.1000 | 1.48749 | 70.44 | |
| 25 | ∞ | 0.1025 | | | |

TABLE 26
Example 9

| | |
|---|---|
| f | 0.73 |
| Bf | 12.06 |
| FNo. | 2.00 |
| 2ω[°] | 164.0 |

TABLE 27A
Example 9

| Sn | 1 | 2 | 3 |
|---|---|---|---|
| KA | 4.9094617E−01 | 1.0000009E+01 | 4.9094617E−01 |
| A3 | 3.9638546E−04 | −1.6972680E−03 | 3.9638546E−04 |
| A4 | −6.0189671E−05 | 2.7631831E−04 | −6.0189671E−05 |
| A5 | −3.0692198E−06 | 1.2340010E−04 | −3.0692198E−06 |
| A6 | 7.6262753E−07 | −2.6959287E−05 | 7.6262753E−07 |
| A7 | −3.0624624E−08 | 2.6793133E−07 | −3.0624624E−08 |
| A8 | −1.7309966E−09 | 2.8436706E−07 | −1.7309966E−09 |
| A9 | 1.6125405E−10 | −1.6039997E−08 | 1.6125405E−10 |
| A10 | −3.5282449E−13 | −1.0632462E−09 | −3.5282449E−13 |
| A11 | −2.9630684E−13 | 1.0674912E−10 | −2.9630684E−13 |
| A12 | 5.5099974E−15 | 6.5127189E−13 | 5.5099974E−15 |
| A13 | 2.4432271E−16 | −2.8195631E−13 | 2.4432271E−16 |
| A14 | −6.6450753E−18 | 4.4586554E−15 | −6.6450753E−18 |
| A15 | −7.6565388E−20 | 2.6840857E−16 | −7.6565388E−20 |
| A16 | 2.5306952E−21 | −7.2724644E−18 | 2.5306952E−21 |

| Sn | 4 | 5 |
|---|---|---|
| KA | 1.0000000E+00 | 1.0000000E+00 |
| A3 | 0.0000000E+00 | 0.0000000E+00 |
| A4 | 2.0172357E−03 | 8.1903058E−04 |
| A5 | 3.4177451E−04 | 7.0657263E−05 |
| A6 | −1.6879978E−04 | −2.6249651E−05 |
| A7 | 1.2930526E−05 | −2.1121445E−06 |
| A8 | 2.6501469E−06 | 1.2454600E−06 |
| A9 | −4.1538302E−07 | −1.2214181E−08 |
| A10 | 1.3554888E−08 | −8.0191633E−09 |

TABLE 27B
Example 9

| Sn | 11 | 12 | 14 |
|---|---|---|---|
| KA | 1.0000000E+00 | 1.0000000E+00 | 1.0000000E+00 |
| A4 | −5.2109493E−04 | −1.9557892E−06 | 9.4776823E−05 |
| A6 | 4.8209933E−06 | −1.2260108E−05 | 1.6779527E−05 |
| A8 | −7.0144987E−07 | 8.9085648E−07 | −2.2959414E−07 |
| A10 | 2.1282570E−08 | −3.8620050E−09 | −1.4328775E−09 |

| Sn | 18 | 19 |
|---|---|---|
| KA | 1.0000000E+00 | 1.0000000E+00 |
| A4 | −6.8121453E−04 | −3.4867120E−04 |
| A6 | 5.5778484E−06 | 5.8182976E−06 |
| A8 | 7.2472671E−08 | 1.0138392E−08 |
| A10 | −1.4085655E−09 | −2.7666925E−10 |
| A12 | 3.5497129E−12 | 3.1592762E−12 |
| A14 | 2.8553154E−17 | 2.6252765E−18 |
| A16 | −4.0778694E−26 | −1.6498109E−25 |
| A18 | 3.2686399E−26 | −2.0421152E−25 |
| A20 | 1.1505085E−35 | −8.7200276E−30 |

### Example 10

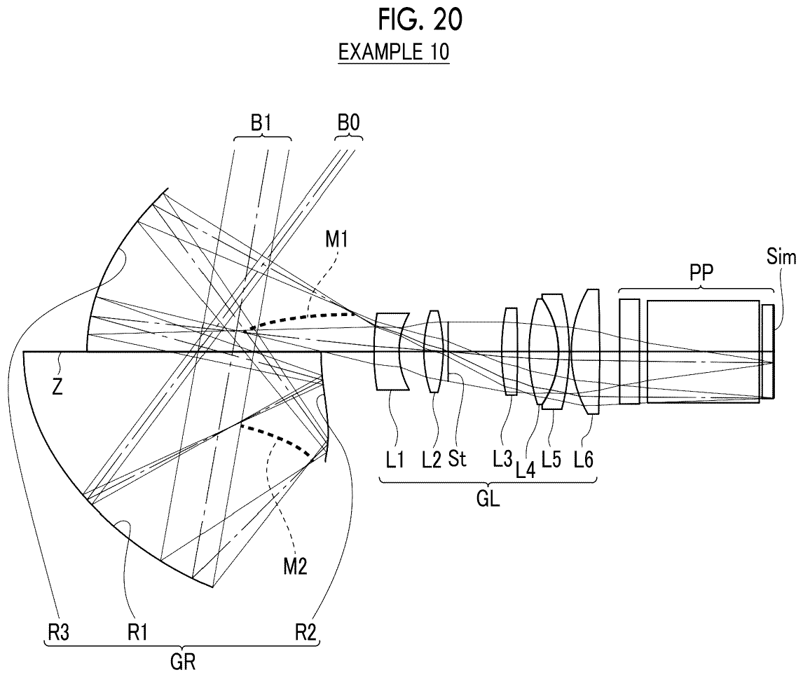

FIG. 20 is a cross-sectional view showing a configuration and luminous fluxes of an imaging optical system according to Example 10. The imaging optical system according to Example 10 consists of a reflective optical system GR and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The refractive optical system GL consists of lenses L1 and L2, an aperture stop St, and lenses L3 to L6 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

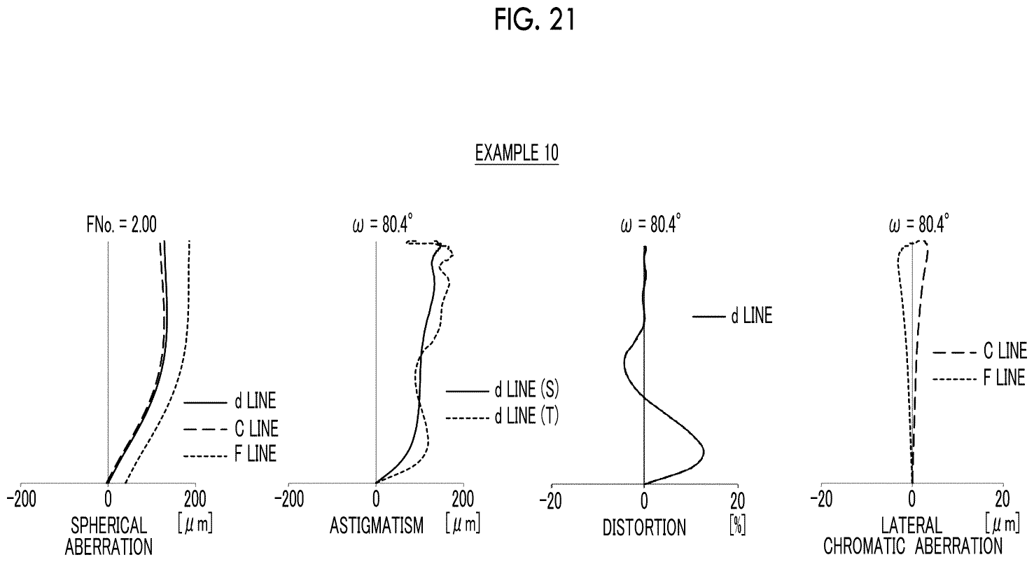

Regarding the imaging optical system according to Example 10, Table 28 shows basic lens data, Table 29 shows specifications, Table 30 shows aspherical coefficients, and FIG. 21 shows each of aberration diagrams in a state where the projection distance is 0.270 meters (m).

TABLE 28
Example 10

| Sn | R | D | Nd | νd | |
|---|---|---|---|---|---|
| *1 | 19.7221 | 29.7898 | | | Reflecting |
| | | | | | Surface |
| *2 | 26.6528 | −23.4282 | | | Reflecting |
| | | | | | Surface |
| *3 | 18.5347 | 28.7425 | | | Reflecting |
| | | | | | Surface |
| *4 | 33.9837 | 2.5143 | 1.80610 | 40.73 | |
| *5 | 8.4813 | 2.4972 | | | |
| 6 | 14.1369 | 1.9148 | 1.51742 | 52.15 | |
| 7 | −17.8042 | 0.5189 | | | |
| 8(St) | ∞ | 5.3607 | | | |
| 9 | 23.8650 | 1.5900 | 1.56883 | 56.04 | |
| 10 | −138.3622 | 1.1545 | | | |
| 11 | 18.4597 | 2.9560 | 1.49700 | 81.61 | |
| 12 | −10.1051 | 1.0782 | 1.84666 | 23.78 | |
| 13 | −24.5577 | 0.2009 | | | |
| 14 | 13.5944 | 2.8007 | 1.55397 | 71.76 | |
| 15 | −181.6933 | 2.0008 | | | |
| 16 | ∞ | 2.0000 | 1.51680 | 64.20 | |
| 17 | ∞ | 0.8000 | | | |
| 18 | ∞ | 11.2000 | 1.72342 | 37.95 | |
| 19 | ∞ | 0.3000 | | | |
| 20 | ∞ | 1.1000 | 1.48749 | 70.44 | |
| 21 | ∞ | −0.0525 | | | |

TABLE 29
Example 10

| | |
|---|---|
| f | 0.85 |
| Bf | 11.60 |
| FNo. | 2.00 |
| 2ω[°] | 160.8 |

TABLE 30
Example 10

| Sn | 1 | 2 | 3 |
|---|---|---|---|
| KA | 3.0254917E−01 | 5.1850683E+00 | −1.8105802E−01 |
| A3 | −9.5031709E−04 | 2.0105494E−03 | −4.9273974E−04 |
| A4 | 1.4950563E−04 | −1.7074575E−03 | 2.4339883E−04 |
| A5 | −1.8907199E−06 | 5.4263026E−04 | −5.5543976E−05 |
| A6 | −4.9759823E−07 | −7.9836465E−05 | 5.8496337E−06 |
| A7 | −1.0287458E−08 | −1.6804738E−06 | −7.9297237E−09 |
| A8 | 2.1940240E−09 | 1.9289363E−06 | −5.4324034E−08 |
| A9 | 6.7227745E−11 | −1.6244194E−07 | 3.5686820E−09 |
| A10 | −7.4972837E−12 | −1.1674184E−08 | 1.1525899E−10 |
| A11 | −8.9394184E−14 | 2.3030681E−09 | −1.8924245E−11 |
| A12 | 1.2624994E−14 | −2.7508297E−11 | 2.2396707E−13 |
| A13 | 2.4630130E−18 | −1.1822177E−11 | 3.6962211E−14 |
| A14 | −9.3301580E−18 | 4.8485752E−13 | −1.0545036E−15 |
| A15 | 3.9711889E−20 | 2.1098666E−14 | −2.3934104E−17 |
| A16 | 2.2377226E−21 | −1.2257663E−15 | 9.2618167E−19 |

| Sn | 4 | 5 |
|---|---|---|
| KA | 1.0000000E+00 | 1.0000000E+00 |
| A3 | 0.0000000E+00 | 0.0000000E+00 |
| A4 | 1.1400003E−04 | 6.4470365E−04 |
| A5 | 3.9438050E−04 | −2.4327474E−04 |
| A6 | −6.8380971E−05 | 2.8039901E−05 |
| A7 | −5.0676829E−05 | −1.8367005E−08 |
| A8 | 1.4369124E−05 | −1.5961557E−07 |
| A9 | 1.1109095E−06 | −4.2072390E−09 |
| A10 | −4.6856118E−07 | 1.3036972E−10 |

### Example 11

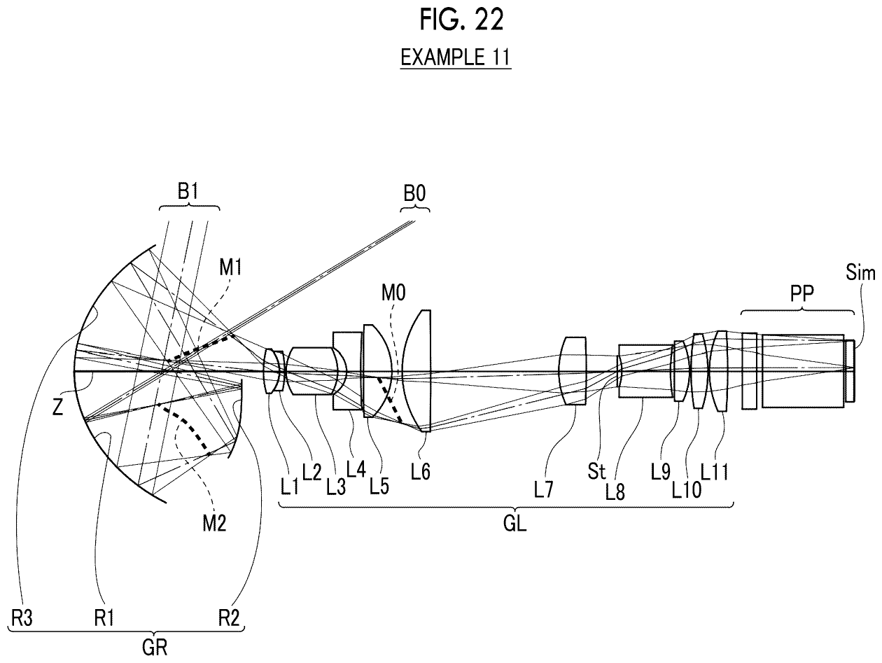

FIG. 22 is a cross-sectional view showing a configuration and luminous fluxes of an imaging optical system according to Example 11. The imaging optical system according to Example 11 consists of a reflective optical system GR and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The first reflecting surface R1 and the third reflecting surface R3 are formed of the same member and have the same surface shape. The refractive optical system GL consists of lenses L1 to L7, an aperture stop St, and lenses L8 to L11 in order from the enlargement side to the reduction side. An intermediate image M0 is formed in the refractive optical system GL. A first intermediate image M1 is formed on the optical path between the refractive optical system GL and the third reflecting surface R3. A second intermediate image M2 is formed on the optical path between the second reflecting surface R2 and the first reflecting surface R1.

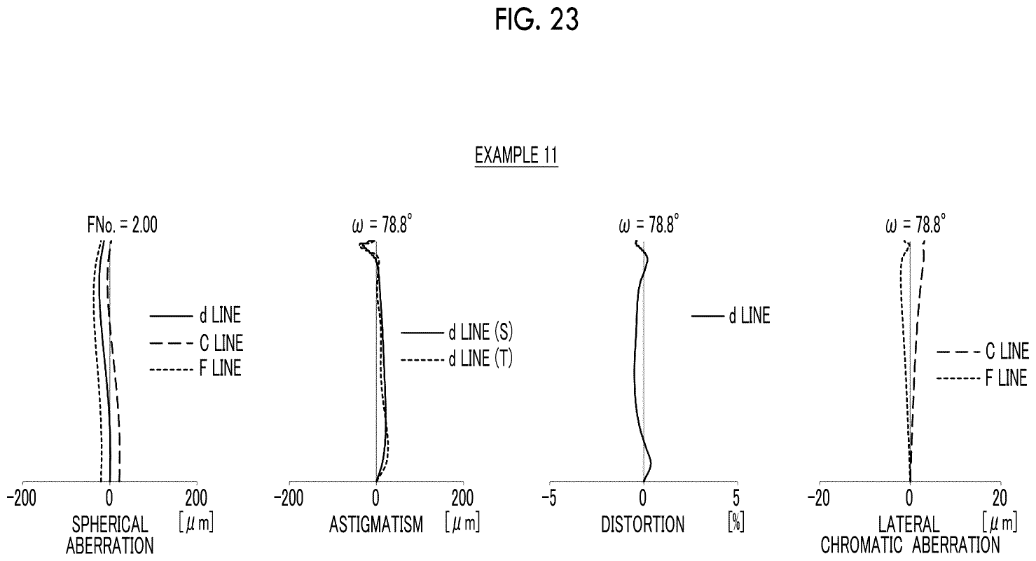

Regarding the imaging optical system according to Example 11, Table 31 shows basic lens data, Table 32 shows specifications, Table 33 shows aspherical coefficients, and FIG. 23 shows each of aberration diagrams in a state where the projection distance is 0.140 meters (m). Table 32 shows an absolute value |f| of the focal length instead of the focal length f.

TABLE 31
Example 11

| Sn | R | D | Nd | νd | |
|---|---|---|---|---|---|
| *1 | 17.4967 | 23.0927 | | | Reflecting |
| | | | | | Surface |
| *2 | −3239.1965 | −23.0927 | | | Reflecting |
| | | | | | Surface |
| *3 | 17.4967 | 26.0934 | | | Reflecting |
| | | | | | Surface |
| 4 | 12.2859 | 2.2342 | 1.58913 | 61.13 | |
| 5 | −5.0122 | 0.6994 | 1.85026 | 32.27 | |
| 6 | −13.6805 | 0.1999 | | | |
| 7 | 6.3445 | 7.1066 | 1.74100 | 52.60 | |
| 8 | −6.7354 | 1.2335 | | | |
| 9 | −3.9500 | 1.9528 | 1.59551 | 39.24 | |
| 10 | 118.6152 | 0.3608 | | | |
| 11 | 262.7594 | 3.9438 | 1.80610 | 33.27 | |
| 12 | −9.5223 | 1.4052 | | | |
| 13 | 15.4270 | 3.9295 | 1.80400 | 46.53 | |
| 14 | −752.5441 | 17.6014 | | | |
| 15 | 12.2971 | 3.7852 | 1.80440 | 39.58 | |
| 16 | −101.2434 | 4.2822 | | | |
| 17(St) | ∞ | 0.6235 | | | |
| 18 | −7.0962 | 6.7201 | 1.80518 | 25.42 | |
| 19 | 24.5860 | 0.5267 | | | |
| 20 | 247.1903 | 2.0947 | 1.60311 | 60.64 | |
| 21 | −10.6507 | 0.2005 | | | |
| 22 | 34.0769 | 2.3348 | 1.60311 | 60.64 | |
| 23 | −18.7415 | 0.2006 | | | |
| 24 | 14.6372 | 2.5154 | 1.60311 | 60.64 | |
| 25 | −94.9181 | 2.0000 | | | |
| 26 | ∞ | 2.0000 | 1.51680 | 64.20 | |
| 27 | ∞ | 0.8000 | | | |
| 28 | ∞ | 11.2000 | 1.72342 | 37.95 | |
| 29 | ∞ | 0.3000 | | | |
| 30 | ∞ | 1.1000 | 1.48749 | 70.44 | |
| 31 | ∞ | 0.1024 | | | |

TABLE 32
Example 11

| | |
|---|---|
| \|f\| | 0.86 |
| Bf | 11.75 |
| FNo. | 2.00 |
| 2ω[°] | 157.6 |

TABLE 33
Example 11

| Sn | 1 | 2 | 3 |
|---|---|---|---|
| KA | 5.2597292E−01 | 1.0000009E+01 | 5.2597292E−01 |
| A3 | −2.1073138E−04 | 1.7831764E−03 | −2.1073138E−04 |
| A4 | 8.1386937E−05 | −1.1849140E−03 | 8.1386937E−05 |
| A5 | −1.6238643E−05 | 3.1555983E−04 | −1.6238643E−05 |
| A6 | 1.5204200E−06 | −3.9981112E−05 | 1.5204200E−06 |
| A7 | −2.9015535E−08 | −7.6696956E−07 | −2.9015535E−08 |
| A8 | −7.5254384E−09 | 7.7950152E−07 | −7.5254384E−09 |
| A9 | 6.0378970E−10 | −5.8371112E−08 | 6.0378970E−10 |
| A10 | 1.2738092E−12 | −3.8509390E−09 | 1.2738092E−12 |
| A11 | −1.8312760E−12 | 6.5236342E−10 | −1.8312760E−12 |
| A12 | 4.7242650E−14 | −5.2227665E−12 | 4.7242650E−14 |
| A13 | 2.0313669E−15 | −2.6486082E−12 | 2.0313669E−15 |
| A14 | −8.6909544E−17 | 8.7731765E−14 | −8.6909544E−17 |
| A15 | −6.2824979E−19 | 3.7683631E−15 | −6.2824979E−19 |
| A16 | 4.4520917E−20 | −1.7709793E−16 | 4.4520917E−20 |

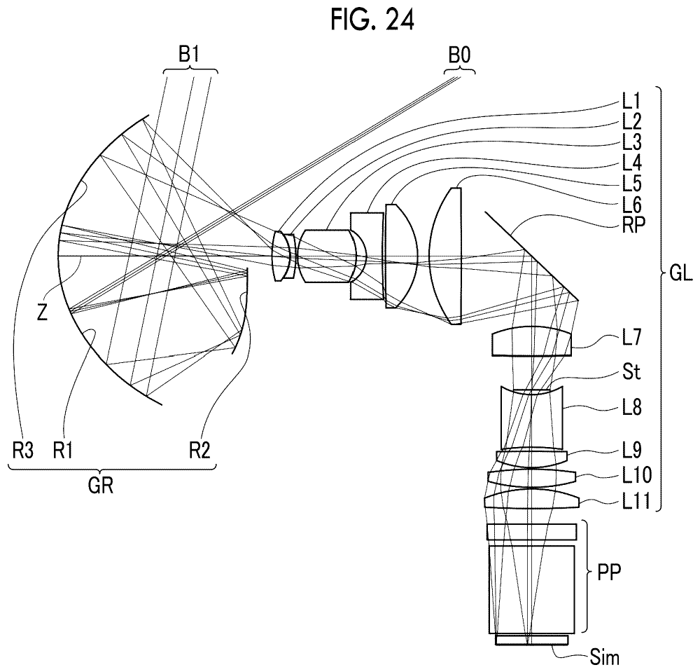

FIG. 24 shows a configuration and luminous fluxes of an imaging optical system according to a modification example of Example 11. FIG. 24 does not show the intermediate image. The imaging optical system of FIG. 24 is different from the imaging optical system according to Example 11, in that a reflecting surface RP having no power that is an optical path bending member is added to the optical path between the lens L6 and the lens L7 of Example 11 and that the optical path in the refractive optical system GL is bent by 90°. Other configurations of the imaging optical system of FIG. 24 are the same as the configurations of the imaging optical system according to Example 11. By bending the optical path, a compact configuration can be achieved.

### Example 12

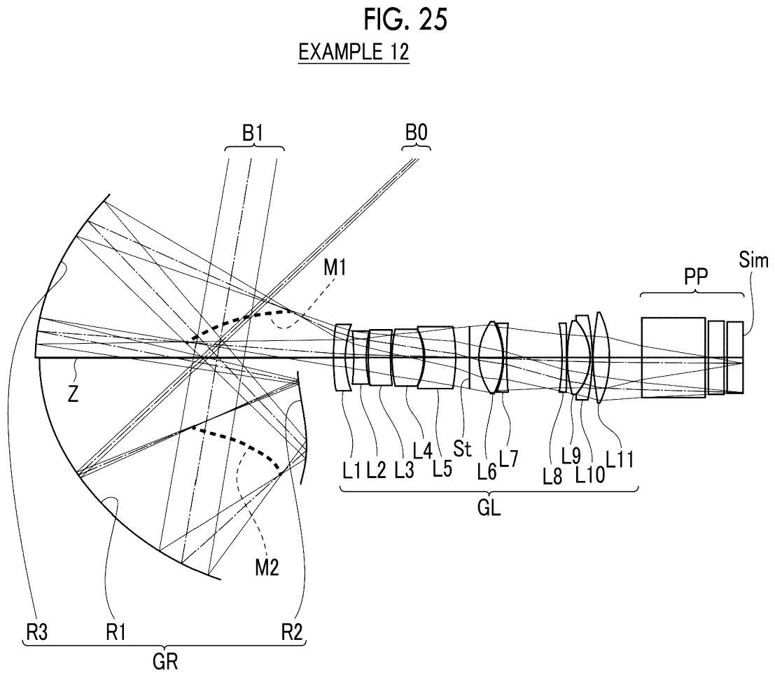

FIG. 25 is a cross-sectional view showing a configuration and luminous fluxes of an imaging optical system according to Example 12. The imaging optical system according to Example 12 consists of a reflective optical system GR and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The refractive optical system GL consists of lenses L1 to L5, an aperture stop St, and lenses L6 to L11 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

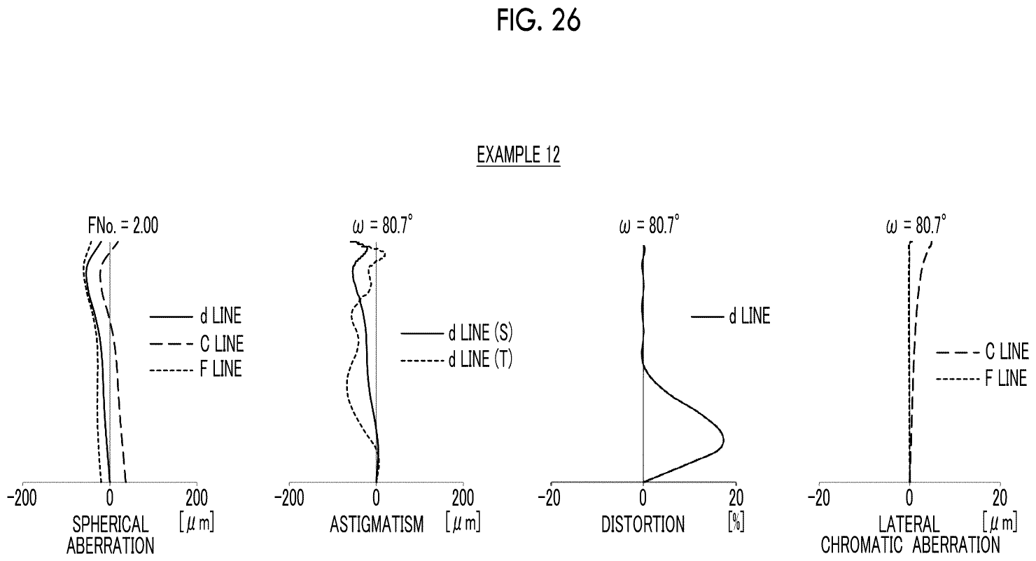

Regarding the imaging optical system according to Example 12, Table 34 shows basic lens data, Table 35 shows specifications, Table 36 shows aspherical coefficients, and FIG. 26 shows each of aberration diagrams in a state where the projection distance is 0.310 meters (m).

TABLE 34
Example 12

| Sn | R | D | Nd | νd | |
|---|---|---|---|---|---|
| *1 | 60.2206 | 81.6099 | | | Reflecting |
| | | | | | Surface |
| *2 | 81.6079 | −82.8631 | | | Reflecting |
| | | | | | Surface |
| *3 | 62.8524 | 94.3880 | | | Reflecting |
| | | | | | Surface |
| *4 | 81.1844 | 3.7267 | 1.69680 | 55.46 | |
| *5 | 25.9113 | 2.6842 | | | |
| 6 | −89.7429 | 3.9596 | 1.72916 | 54.54 | |
| 7 | 40.6401 | 0.6727 | | | |
| 8 | 86.0516 | 7.0028 | 1.59270 | 35.45 | |
| 9 | 81.8810 | 0.5159 | | | |
| 10 | 46.4279 | 10.0000 | 1.68893 | 31.16 | |
| 11 | −22.7624 | 0.3390 | | | |
| 12 | −20.8945 | 9.8153 | 1.80518 | 25.46 | |
| 13 | −60.2674 | 4.4129 | | | |
| 14(St) | ∞ | 2.9908 | | | |
| *15 | 19.9230 | 7.5669 | 1.58313 | 59.46 | |
| *16 | −25.1631 | 0.2004 | | | |
| 17 | −30.9548 | 1.0008 | 1.83481 | 42.72 | |
| 18 | 137.8022 | 17.5762 | | | |
| 19 | −73.8062 | 1.4638 | 1.75520 | 27.53 | |
| 20 | −406.5987 | 0.2007 | | | |
| 21 | 48.0208 | 7.0673 | 1.49700 | 81.61 | |
| 22 | −19.0206 | 0.6991 | 1.90366 | 31.31 | |
| 23 | −70.8502 | 0.2462 | | | |
| *24 | 53.2224 | 5.1890 | 1.68948 | 31.02 | |
| *25 | −44.7548 | 10.2900 | | | |
| 26 | ∞ | 20.0900 | 1.51680 | 64.20 | |
| 27 | ∞ | 1.0000 | | | |
| 28 | ∞ | 5.0000 | 1.51680 | 64.20 | |
| 29 | ∞ | 1.0000 | | | |
| 30 | ∞ | 5.0000 | 1.51680 | 64.20 | |
| 31 | ∞ | 0.1106 | | | |

TABLE 35
Example 12

| | |
|---|---|
| f | 2.00 |
| Bf | 32.22 |
| FNo. | 2.00 |
| 2ω[°] | 161.4 |

TABLE 36
Example 12

| Sn | 1 | 2 | 3 |
|---|---|---|---|
| KA | 5.8043740E−01 | −2.3913695E+00 | 5.8043740E−01 |
| A3 | −7.4985026E−05 | 7.2074828E−05 | 8.3349249E−06 |
| A4 | 8.4566573E−07 | −1.2779574E−06 | −6.2129703E−07 |
| A5 | 6.4426152E−08 | 7.2773849E−07 | −1.5240119E−08 |
| A6 | 1.1488893E−10 | −1.0922819E−07 | 8.7212446E−10 |
| A7 | −7.8040365E−11 | 2.9211367E−09 | −1.2819981E−11 |
| A8 | 5.4664564E−13 | 1.2195307E−10 | −1.0984121E−13 |
| A9 | 2.9857390E−14 | −6.5478913E−12 | 5.4021628E−15 |
| A10 | −3.1646009E−16 | −8.6151421E−15 | −2.7820234E−17 |
| A11 | −5.1675326E−18 | 4.7991902E−15 | −7.8564307E−19 |
| A12 | 6.5664305E−20 | −4.4225499E−17 | 7.7438685E−21 |
| A13 | 4.2549461E−22 | −1.5223313E−18 | 5.0908793E−23 |
| A14 | −6.0723818E−24 | 2.1922570E−20 | −6.6620690E−25 |
| A15 | −1.3595469E−26 | 1.7807223E−22 | −1.2491102E−27 |
| A16 | 2.1206974E−28 | −3.1582785E−24 | 1.9920741E−29 |

| Sn | 15 | 16 |
|---|---|---|
| KA | 1.0000000E+00 | 1.0000000E+00 |
| A4 | −1.4848936E−05 | 6.4277719E−06 |
| A6 | 1.0200199E−08 | 5.8896259E−08 |
| A8 | 8.7798782E−11 | −1.5509282E−10 |
| A10 | −6.4638478E−13 | 5.9478472E−13 |
| A12 | 2.2684152E−15 | |
| A14 | 1.7998038E−18 | |
| A16 | 1.3696541E−22 | |
| A18 | 1.5736779E−22 | |
| A20 | −3.0774344E−28 | |

| Sn | 4 | 5 | 24 | 25 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −2.7837810E−05 | −9.6563062E−05 | −1.9439887E−05 | −1.4444584E−05 |
| A5 | −2.6405883E−07 | −3.4352260E−06 | 2.7062687E−07 | 3.8005646E−07 |
| A6 | −1.2706829E−08 | 9.4433971E−07 | 1.5407384E−08 | 2.5103668E−08 |
| A7 | 5.1007940E−08 | −1.1515027E−08 | −3.4317575E−09 | −5.7200576E−09 |
| A8 | −1.0452357E−09 | 1.9085207E−10 | 1.7409675E−10 | 2.4507319E−10 |
| A9 | −1.2318581E−10 | −9.0221929E−12 | 8.8199570E−12 | 1.6016097E−11 |
| A10 | 3.4466825E−12 | −1.2103850E−12 | −5.4198797E−13 | −9.3448554E−13 |
| A11 | | | −7.4486118E−15 | −1.3805968E−14 |
| A12 | | | 4.5622202E−16 | 9.4808810E−16 |

### Example 13

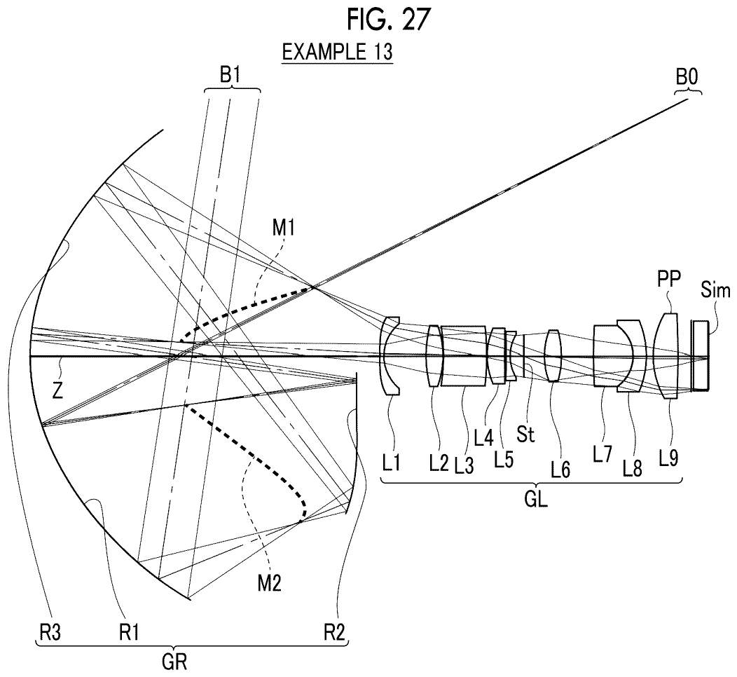

FIG. 27 is a cross-sectional view showing a configuration and luminous fluxes of an imaging optical system according to Example 13. The imaging optical system according to Example 13 consists of a reflective optical system GR and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The first reflecting surface R1 and the third reflecting surface R3 are formed of the same member and have the same surface shape. The refractive optical system GL consists of lenses L1 to L5, an aperture stop St, and lenses L6 to L9 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

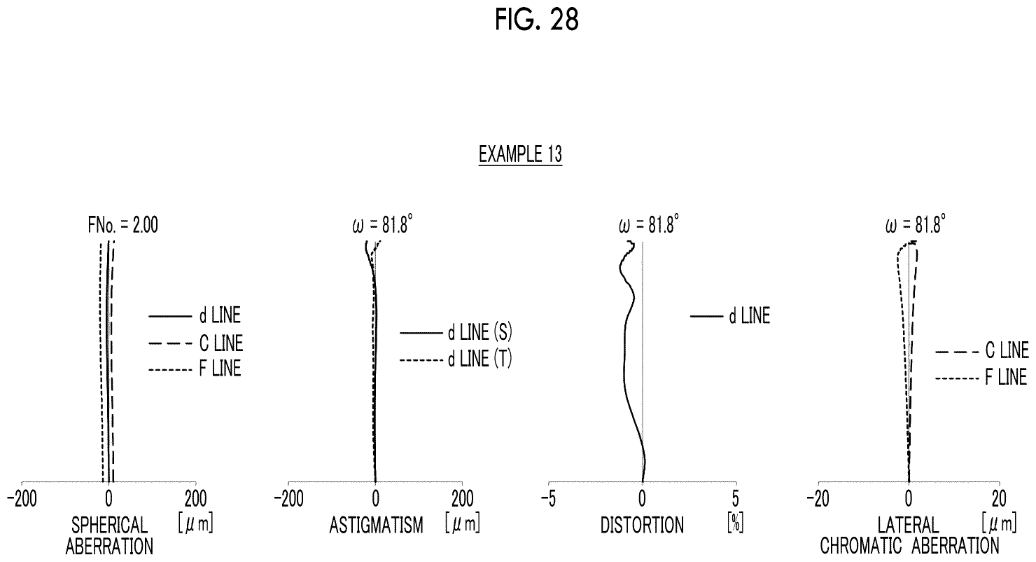

Regarding the imaging optical system according to Example 13, Table 37 shows basic lens data, Table 38 shows specifications, Table 39 shows aspherical coefficients, and FIG. 28 shows each of aberration diagrams in a state where the projection distance is 65.8 millimeters (mm).

TABLE 37
Example 13

| Sn | R | D | Nd | νd | |
|---|---|---|---|---|---|
| *1 | 16.7258 | 24.6103 | | | Reflecting |
| | | | | | Surface |
| *2 | −4001.4405 | −24.6103 | | | Reflecting |
| | | | | | Surface |
| *3 | 16.7258 | 26.3381 | | | Reflecting |
| | | | | | Surface |
| *4 | 200.0032 | 0.3006 | 1.80835 | 40.55 | |
| 5 | 3.3569 | 3.1816 | | | |
| *6 | 8.6879 | 1.2834 | 1.49700 | 81.61 | |
| 7 | −7.0641 | 0.0305 | | | |
| 8 | −15.1995 | 3.2669 | 1.94595 | 17.98 | |
| 9 | −20.3023 | 0.0293 | | | |
| 10 | 5.4811 | 1.3201 | 1.65253 | 39.48 | |
| 11 | 323.4446 | 0.1094 | | | |
| 12 | −53.3693 | 0.2998 | 1.51742 | 52.43 | |
| 13 | 3.3312 | 1.0301 | | | |
| 14(St) | ∞ | 1.5494 | | | |
| 15 | 5.6741 | 1.2914 | 1.49700 | 81.61 | |
| 16 | −7.6492 | 2.4052 | | | |
| 17 | 34.4718 | 3.0025 | 1.49700 | 81.61 | |
| 18 | −2.9584 | 1.0009 | 1.84666 | 23.78 | |
| 19 | −7.2492 | 0.5147 | | | |
| 20 | 6.8664 | 1.8658 | 1.51680 | 64.20 | |
| 21 | −66.5464 | 1.1731 | | | |
| 22 | ∞ | 1.1000 | 1.51680 | 64.20 | |
| 23 | ∞ | 0.0548 | | | |

TABLE 38
Example 13

| | |
|---|---|
| f | 0.39 |
| Bf | 1.95 |
| FNo. | 2.00 |
| 2ω[°] | 163.6 |

TABLE 39
Example 13

| Sn | 1 | 2 | 3 |
|---|---|---|---|
| KA | 5.3516911E−01 | 9.9999995E+00 | 5.3516911E−01 |
| A3 | 4.4803840E−05 | −4.9779482E−04 | 4.4803840E−05 |
| A4 | −6.8272899E−06 | 6.4523971E−05 | −6.8272899E−06 |
| A5 | −1.6773624E−06 | 7.2073694E−05 | −1.6773624E−06 |
| A6 | −1.1032291E−07 | −1.4131749E−05 | −1.1032291E−07 |
| A7 | 1.9936244E−08 | −4.8927042E−08 | 1.9936244E−08 |
| A8 | 4.2129534E−10 | 1.5227985E−07 | 4.2129534E−10 |
| A9 | −1.0621552E−10 | −5.5897981E−09 | −1.0621552E−10 |
| A10 | 3.1700544E−13 | −6.5996130E−10 | 3.1700544E−13 |
| A11 | 2.4509615E−13 | 3.7164976E−11 | 2.4509615E−13 |
| A12 | −3.2823879E−15 | 1.2406766E−12 | −3.2823879E−15 |
| A13 | −2.5174634E−16 | −9.2555591E−14 | −2.5174634E−16 |
| A14 | 4.6954392E−18 | −6.7139865E−16 | 4.6954392E−18 |
| A15 | 9.5320014E−20 | 8.1674111E−17 | 9.5320014E−20 |
| A16 | −2.0662676E−21 | −3.6779778E−19 | −2.0662676E−21 |

| Sn | 4 | 6 |
|---|---|---|
| KA | 1.0000000E+00 | 1.0000000E+00 |
| A4 | 9.0392736E−03 | −1.9075787E−03 |
| A6 | −8.4491719E−04 | 5.9303311E−05 |
| A8 | 9.6355350E−05 | 1.0320394E−05 |
| A10 | −6.9557795E−06 | −8.4652194E−07 |
| A12 | 2.3297281E−07 | |
| A14 | 4.7480483E−09 | |
| A16 | −4.3030416E−10 | |

### Example 14

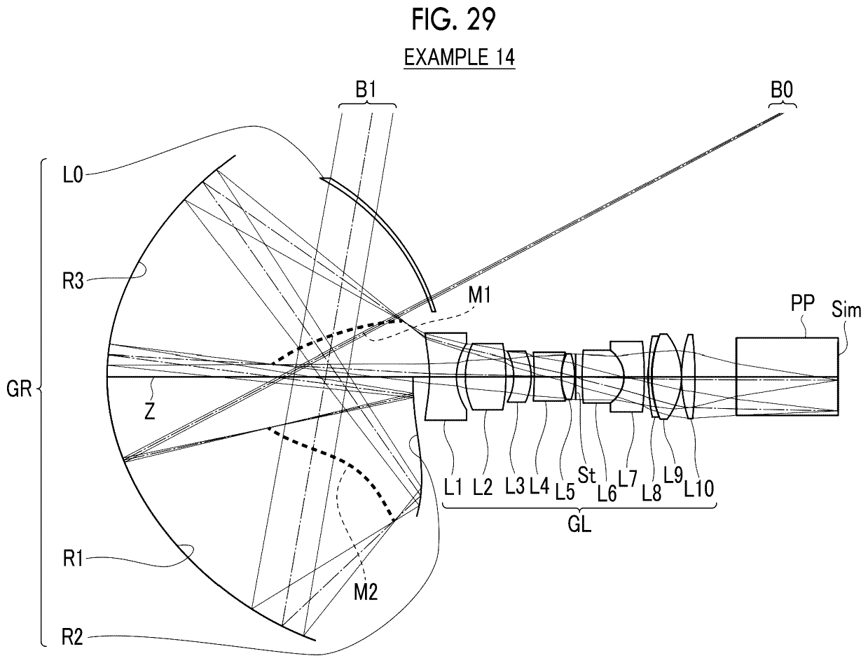

FIG. 29 is a cross-sectional view showing a configuration and luminous fluxes of an imaging optical system according to Example 14. The imaging optical system according to Example 14 consists of a reflective optical system GR and a refractive optical system GL along the optical path in order from the enlargement side to the reduction side. The reflective optical system GR consists of a lens L0, a first reflecting surface R1 having a positive power, a second reflecting surface R2 having a power, and a third reflecting surface R3 having a positive power along the optical path in order from the enlargement side to the reduction side. The first reflecting surface R1 and the third reflecting surface R3 are formed of the same member and have the same surface shape. A luminous flux that is reflected from the first reflecting surface R1 and travels toward the enlargement side transmits through the lens L0, and is incident into the screen (not shown). The refractive optical system GL consists of lenses L1 to L5, an aperture stop St, and lenses L6 to L10 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

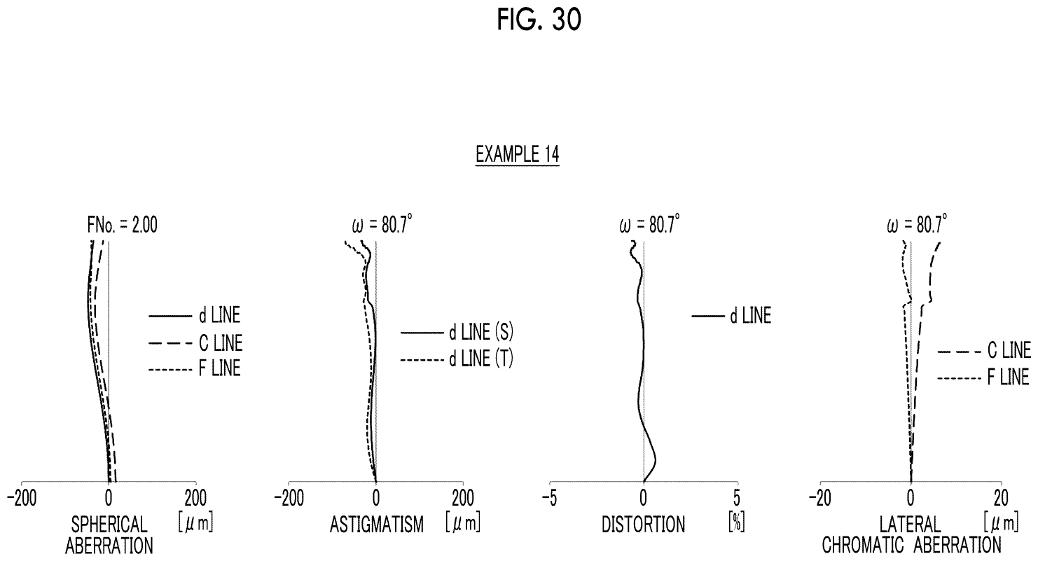

Regarding the imaging optical system according to Example 14, Table 40 shows basic lens data, Table 41 shows specifications, Table 42 shows aspherical coefficients, and FIG. 30 shows each of aberration diagrams in a state where the projection distance is 0.350 meters (m).

TABLE 40
Example 14

| Sn | R | D | Nd | νd | |
|---|---|---|---|---|---|
| 1 | −72.2166 | −1.0000 | 1.51680 | 64.20 | |
| 2 | −70.1192 | −99.0000 | | | |
| *3 | 68.4344 | 90.4401 | | | Reflecting |
| | | | | | Surface |
| *4 | 124.9403 | −90.4401 | | | Reflecting |
| | | | | | Surface |
| *5 | 68.4344 | 95.3479 | | | Reflecting |
| | | | | | Surface |
| *6 | −41.4856 | 7.9989 | 1.69350 | 53.18 | |
| 7 | 18.7543 | 2.6281 | | | |
| 8 | 25.0592 | 12.0008 | 1.69895 | 30.13 | |
| 9 | −54.8102 | 2.3371 | | | |
| 10 | −16.6107 | 5.1325 | 1.48749 | 70.44 | |
| 11 | −18.8938 | 0.9345 | | | |
| 12 | −103.6085 | 8.0005 | 1.77250 | 49.62 | |
| 13 | 21.4501 | 0.0511 | | | |
| 14 | 17.3458 | 3.9095 | 1.48749 | 70.44 | |
| 15(St) | −23.7551 | 2.2322 | | | |
| 16 | 107.9483 | 12.4152 | 1.48749 | 70.44 | |
| 17 | −10.0745 | 5.9999 | 1.83481 | 42.72 | |
| 18 | −99.6193 | 1.0479 | | | |
| 19 | 68.4501 | 0.8821 | 1.80420 | 46.50 | |
| 20 | 35.1266 | 0.1960 | | | |
| 21 | 37.2551 | 8.7072 | 1.59282 | 68.62 | |
| 22 | −22.1688 | 0.0300 | | | |
| 23 | 43.1546 | 3.9884 | 1.51633 | 64.06 | |
| *24 | −108.3105 | 12.2900 | | | |
| 25 | ∞ | 30.0900 | 1.51680 | 64.20 | |
| 26 | ∞ | 0.0511 | | | |

TABLE 41
Example 14

| | |
|---|---|
| f | 1.84 |
| Bf | 32.17 |
| FNo. | 2.00 |
| 2ω[°] | 161.4 |

TABLE 42
Example 14

| Sn | 3 | 4 | 5 |
|---|---|---|---|
| KA | 5.9549660E−01 | 7.0407163E+00 | 5.9549660E−01 |
| A3 | −2.8186123E−07 | −1.0526407E−04 | −2.8186123E−07 |
| A4 | 2.7050203E−07 | 1.5627378E−05 | 2.7050203E−07 |
| A5 | −1.7925325E−08 | 8.8542095E−08 | −1.7925325E−08 |
| A6 | −3.0297673E−11 | −6.9581033E−08 | −3.0297673E−11 |
| A7 | 9.7275184E−12 | 1.6760577E−09 | 9.7275184E−12 |
| A8 | −4.1700097E−14 | 5.4517477E−11 | −4.1700097E−14 |
| A9 | −3.1189692E−15 | −2.2682310E−12 | −3.1189692E−15 |
| A10 | 2.6112870E−17 | −9.2155994E−15 | 2.6112870E−17 |
| A11 | 4.8944073E−19 | 1.1742342E−15 | 4.8944073E−19 |
| A12 | −5.3587450E−21 | −5.5018990E−18 | −5.3587450E−21 |
| A13 | −3.5635322E−23 | −2.7383535E−19 | −3.5635322E−23 |
| A14 | 4.5777099E−25 | 2.4109042E−21 | 4.5777099E−25 |
| A15 | 9.7533588E−28 | 2.3994848E−23 | 9.7533588E−28 |
| A16 | −1.4012626E−29 | −2.6656661E−25 | −1.4012626E−29 |

| Sn | 6 | 24 |
|---|---|---|
| KA | 1.0000000E+00 | 1.0000000E+00 |
| A4 | 4.0854263E−05 | −1.9039244E−07 |
| A6 | −2.3694877E−07 | 8.7760069E−09 |
| A8 | 2.4416565E−09 | 2.6778716E−11 |
| A10 | −1.3697156E−11 | −1.0536610E−13 |
| A12 | 2.4437101E−14 | |
| A14 | 7.2336882E−17 | |
| A16 | −2.5077903E−19 | |

### Example 15

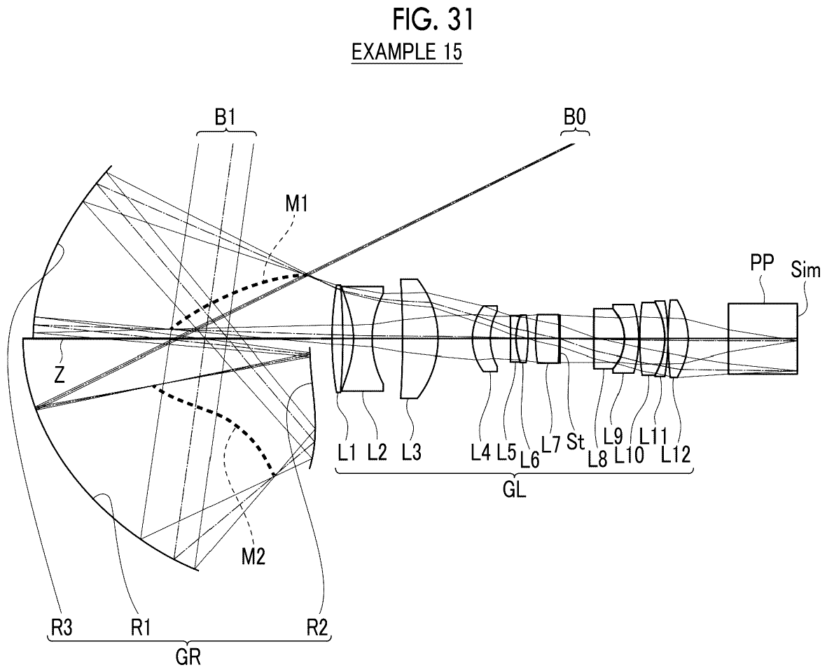

FIG. 31 is a cross-sectional view showing a configuration and luminous fluxes of an imaging optical system according to Example 15. The imaging optical system according to Example 15 consists of a reflective optical system GR and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The refractive optical system GL consists of lenses L1 to L7, an aperture stop St, and lenses L8 to L12 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1. All of the lenses L1 to L12 are uncemented lenses. The lenses L1 and L2 are in edge contact with each other, the lenses L5 and L6 are in edge contact with each other, the lenses L8 and L9 are in edge contact with each other, and the lenses L10 and L11 are in edge contact with each other.

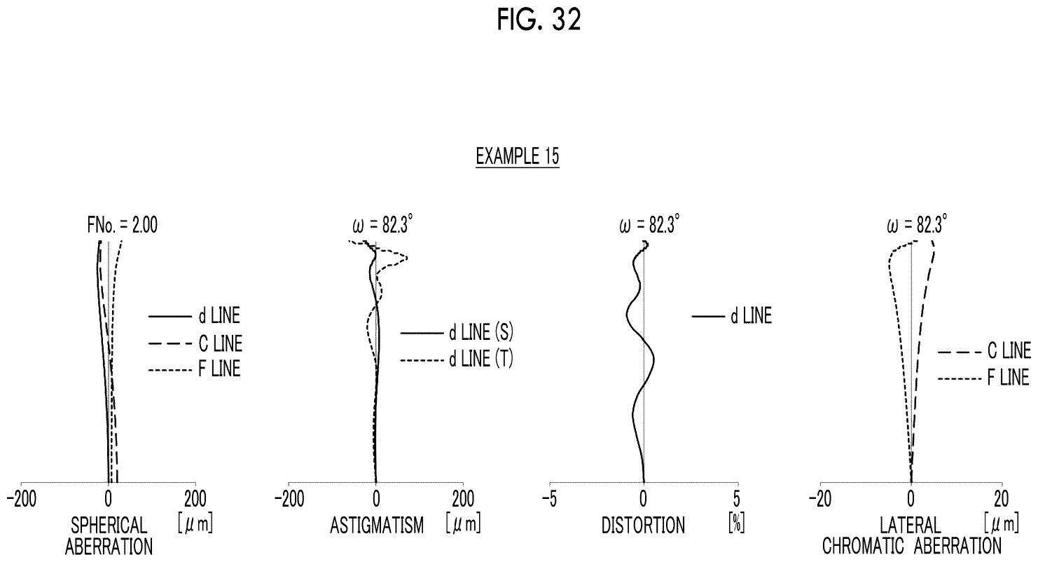

Regarding the imaging optical system according to Example 15, Table 43 shows basic lens data, Table 44 shows specifications, Table 45 shows aspherical coefficients, and FIG. 32 shows each of aberration diagrams in a state where the projection distance is 0.450 meters (m).

TABLE 43
Example 15

| Sn | R | D | Nd | νd | |
|---|---|---|---|---|---|
| *1 | 90.2341 | 121.0152 | | | Reflecting |
| | | | | | Surface |
| *2 | 149.9917 | −116.7221 | | | Reflecting |
| | | | | | Surface |
| *3 | 82.0576 | 126.2175 | | | Reflecting |
| | | | | | Surface |
| 4 | 147.0020 | 4.5626 | 1.75500 | 52.32 | |
| 5 | −282.8971 | 4.5157 | | | |
| *6 | −38.0696 | 7.8710 | 1.58913 | 61.15 | |
| 7 | 43.9474 | 12.9105 | | | |
| 8 | −415.6530 | 15.0009 | 1.49700 | 81.61 | |
| 9 | −43.3102 | 14.5359 | | | |
| 10 | 24.3532 | 7.5730 | 1.51742 | 52.43 | |
| 11 | 26.6112 | 8.6274 | | | |
| 12 | −290.4969 | 2.2196 | 1.80420 | 46.50 | |
| 13 | 28.5551 | 0.1006 | | | |
| 14 | 29.8372 | 5.0107 | 1.48749 | 70.44 | |
| 15 | −64.6932 | 3.1662 | | | |
| 16 | 65.2724 | 10.0009 | 1.59270 | 35.31 | |
| 17(St) | −148.8306 | 14.6816 | | | |
| 18 | 4315.8310 | 12.6388 | 1.49700 | 81.61 | |
| 19 | −21.2264 | 0.1000 | | | |
| 20 | −20.9166 | 6.0006 | 1.87070 | 40.73 | |
| 21 | −53.8837 | 0.4403 | | | |
| 22 | 127.3457 | 10.5340 | 1.59282 | 68.62 | |
| 23 | −33.0853 | 0.1008 | | | |
| 24 | −32.5026 | 1.3073 | 1.87070 | 40.73 | |
| 25 | −102.2290 | 0.0768 | | | |
| 26 | 163.3167 | 8.4960 | 1.51633 | 64.06 | |
| *27 | −31.1694 | 17.0500 | | | |
| 28 | ∞ | 29.1000 | 1.51680 | 64.20 | |
| 29 | ∞ | 0.0527 | | | |

TABLE 44
Example 15

| | |
|---|---|
| f | 1.97 |
| Bf | 36.28 |
| FNo. | 2.00 |
| 2ω[°] | 164.6 |

TABLE 45
Example 15

| Sn | 1 | 2 | 3 |
|---|---|---|---|
| KA | 6.5914628E−01 | 3.4539601E+00 | −1.3116964E−01 |
| A3 | 2.1548483E−06 | −2.1313374E−05 | −1.3915739E−07 |
| A4 | −1.5360675E−07 | −7.4587362E−08 | −2.7945797E−07 |
| A5 | 6.6983099E−09 | 4.6061723E−08 | 9.4556008E−09 |
| A6 | −1.4176851E−10 | −3.9462531E−09 | −1.5066791E−10 |
| A7 | −1.2447356E−12 | 4.1673669E−11 | −1.8442275E−12 |
| A8 | 5.9720373E−14 | 1.5706434E−12 | 1.0028316E−13 |
| A9 | −1.4227822E−16 | −2.8782209E−14 | −6.9282462E−16 |
| A10 | −8.0998791E−18 | −2.1648156E−16 | −1.4414893E−17 |
| A11 | 4.1608552E−20 | 6.3776115E−18 | 2.0155769E−19 |
| A12 | 4.7896343E−22 | 4.6367437E−21 | 4.5384688E−22 |
| A13 | −2.8847728E−24 | −6.1641138E−22 | −1.7324881E−23 |
| A14 | −1.1931002E−26 | 1.2378467E−24 | 3.6650907E−26 |
| A15 | 6.4584728E−29 | 2.2113758E−26 | 4.9430537E−28 |
| A16 | 8.2230185E−32 | −7.2188497E−29 | −1.9793978E−30 |

| Sn | 6 | 27 |
|---|---|---|
| KA | 1.0000000E+00 | 1.0000000E+00 |
| A4 | 1.4606741E−05 | 2.6117235E−06 |
| A6 | −4.1218575E−08 | 2.5898513E−09 |
| A8 | 1.9477434E−10 | 8.9930123E−12 |
| A10 | −6.0670602E−13 | −1.1014848E−14 |
| A12 | 1.1239185E−15 | |
| A14 | −1.1288372E−18 | |
| A16 | 4.7574357E−22 | |

Table 46 shows the corresponding values of Conditional Expressions (1) to (8) and the value of the maximum image height Y regarding the imaging optical systems according to Examples 1 to 15. Preferable ranges of the conditional expressions may be set by using the corresponding values of the examples shown in Table 46 as the upper limits or the lower limits of the conditional expressions.

TABLE 46

| Expression | | Example | Example | Example | Example | Example |
|---|---|---|---|---|---|---|
| No. | | 1 | 2 | 3 | 4 | 5 |
| (1) | tanω | 6.30 | 10.92 | 5.23 | 4.72 | 4.88 |
| (2) | \|β × d/D0\| | 105.4 | 178 | 84.4 | 103.4 | 86.4 |
| (3) | (RM1 + RM2 + RM3)/Y | 17.33 | 15.55 | 19.6 | 11.14 | 14.84 |
| (4) | RM1/d | 0.36 | 0.33 | 0.32 | 0.28 | 0.22 |
| (5) | RM3/d | 0.30 | 0.24 | 0.25 | 0.29 | 0.24 |
| (6) | fm1/fM3 | 1 | 1.18 | 1 | 0.36 | 0.36 |
| (7) | \|dM1M2\|/d | 0.42 | 0.39 | 0.38 | 0.29 | 0.32 |
| (8) | νp | 64.06 | 81.61 | 60.64 | 74.70 | 54.54 |
| | Y | 11.00 | 12.00 | 11.20 | 11.275 | 11.275 |
| Expression | | Example | Example | Example | Example | Example |
| No. | | 6 | 7 | 8 | 9 | 10 |
| (1) | tanω | 5.82 | 6.10 | 5.33 | 7.13 | 5.87 |
| (2) | \|β × d/D0\| | 89.8 | 88.95 | 91.99 | 113.1 | 84.21 |
| (3) | (RM1 + RM2 + RM3)/Y | 13.85 | 12.89 | 14.4 | 11.51 | 10.63 |
| (4) | RM1/d | 0.35 | 0.32 | 0.30 | 0.27 | 0.33 |
| (5) | RM3/d | 0.25 | 0.26 | 0.24 | 0.21 | 0.22 |
| (6) | fM1/fM3 | 1 | 1 | 0.97 | 1 | 1.06 |
| (7) | \|dM1M2\|/d | 0.43 | 0.40 | 0.37 | 0.33 | 0.4 |
| (8) | νp | 64.06 | 59.05 | 71.68 | 64.20 | 71.76 |
| | Y | 4.325 | 5.1 | 11.29 | 5.1 | 4.85 |
| Expression | | Example | Example | Example | Example | Example |
| No. | | 11 | 12 | 13 | 14 | 15 |
| (1) | tanω | 5.05 | 6.11 | 7 | 6.06 | 7.31 |
| (2) | \|β × d/D0\| | 114.8 | 95.8 | 105.3 | 101.2 | 143.1 |
| (3) | (RM1 + RM2 + RM3)/Y | 11.11 | 13.54 | 17.92 | 16.75 | 16.33 |
| (4) | RM1/d | 0.17 | 0.32 | 0.37 | 0.37 | 0.30 |
| (5) | RM3/d | 0.17 | 0.23 | 0.3 | 0.3 | 0.22 |
| (6) | fM1/fM3 | 1 | 0.96 | 1 | 1 | 1.10 |
| (7) | \|dM1M2\|/d | 0.21 | 0.37 | 0.50 | 0.42 | 0.36 |
| (8) | νp | 60.64 | 31.02 | 64.20 | 64.06 | 64.06 |
| | Y | 4.325 | 11.6 | 2.6 | 11.00 | 14.00 |

The imaging optical systems according to Examples 1 to 15 are small-sized. In particular, the distance on the optical axis from the first reflecting surface to the display surface Sim is configured to be short. The imaging optical systems according to Examples 1 to 15 have a total wide angle of view of 150 degrees or more and have a wide angle of view. In addition, in the imaging optical systems according to Examples 1 to 15, various aberrations are favorably corrected.

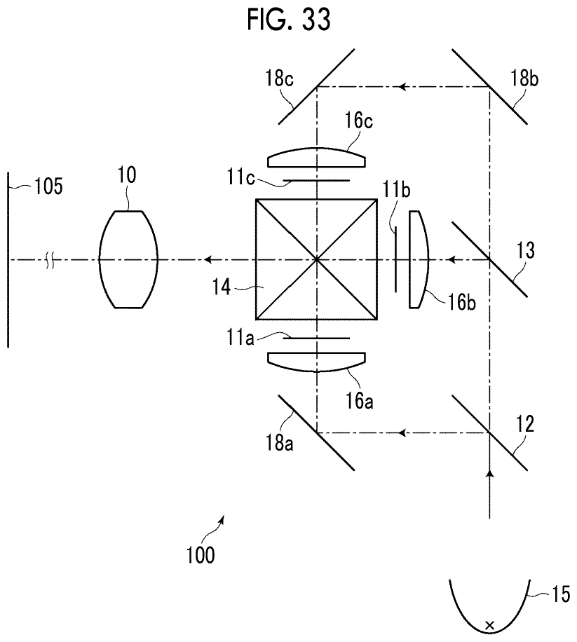

Next, a projection type display device according to an embodiment of the present disclosure will be described. FIG. 33 is a schematic configuration diagram showing the projection type display device according to an embodiment of the present disclosure. A projection type display device 100 shown in FIG. 33 includes an imaging optical system 10 according to the embodiment of the present disclosure, a light source 15, and transmissive display elements 11a to 11c as light valves corresponding to each color light and outputting an optical image. Further, the projection type display device 100 includes dichroic mirrors 12 and 13 for color separation, a cross dichroic prism 14 for color synthesis, condenser lenses 16a to 16c, and total reflection mirrors 18a to 18c for deflecting the optical path. In addition, FIG. 33 schematically shows the imaging optical system 10. Further, an integrator is disposed between the light source 15 and the dichroic mirror 12, but is not shown in FIG. 33.

White light emitted from the light source 15 is separated into three colored luminous fluxes (green light, blue light, and red light) through the dichroic mirrors 12 and 13. Next, the three colored luminous fluxes pass through the condenser lenses 16a to 16c, are incident into and modulated by the transmissive display elements 11a to 11c respectively corresponding to the respective colored luminous fluxes, are subjected to color synthesis by the cross dichroic prism 14, and are subsequently incident into the imaging optical system 10. The imaging optical system 10 projects an optical image, which is based on the modulated light modulated through the transmissive display elements 11a to 11c, onto a screen 105.

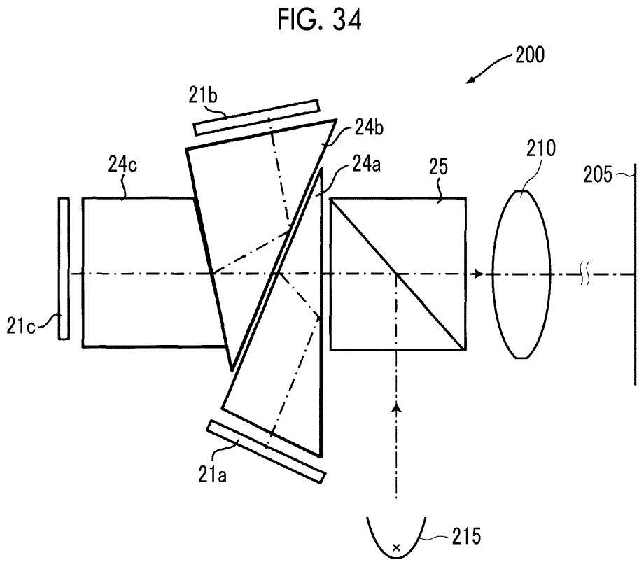

FIG. 34 is a schematic configuration diagram showing a projection type display device according to another embodiment of the present disclosure. A projection type display device 200 shown in FIG. 34 includes an imaging optical system 210 according to the embodiment of the present disclosure, a light source 215, and digital micromirror device (DMD: registered trademark) elements 21a to 21c as light valves corresponding to each color light and outputting an optical image. Further, the projection type display device 200 includes total internal reflection (TIR) prisms 24a to 24c for color separation and color synthesis, and a polarization separating prism 25 that separates illumination light and projection light. In addition, FIG. 34 schematically shows the imaging optical system 210. Further, an integrator is disposed between the light source 215 and the polarization separating prism 25, but is not shown in FIG. 34.

White light emitted from the light source 215 is reflected from a reflecting surface inside the polarization separating prism 25, and is separated into three colored luminous fluxes (green light, blue light, and red light) by the TIR prisms 24a to 24c. The separated colored luminous fluxes with the respective colors are respectively incident into and modulated through the corresponding DMD elements 21a to 21c, travel through the TIR prisms 24a to 24c again in a reverse direction, are subjected to color synthesis, are subsequently transmitted through the polarization separating prism 25, and are incident into the imaging optical system 210. The imaging optical system 210 projects an optical image, which is based on the modulated light modulated through the DMD elements 21a to 21c, onto a screen 205.

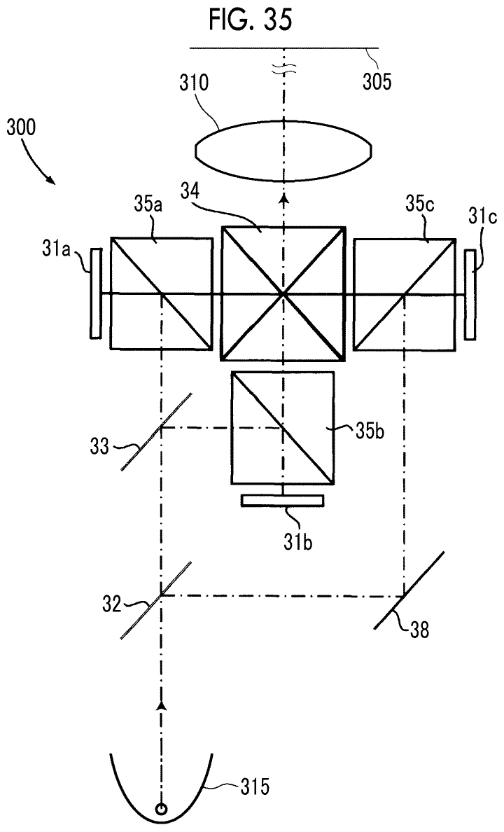

FIG. 35 is a schematic configuration diagram showing a projection type display device according to still another embodiment of the present disclosure. A projection type display device 300 shown in FIG. 35 includes an imaging optical system 310 according to the embodiment of the present disclosure, a light source 315, reflective display elements 31a to 31c as light valves each corresponding to each color light, dichroic mirrors 32 and 33 for color separation, a cross dichroic prism 34 for color synthesis, a total reflection mirror 38 for deflecting the optical path, and polarization separating prisms 35a to 35c. In addition, FIG. 35 schematically shows the imaging optical system 310. Further, an integrator is disposed between the light source 315 and the dichroic mirror 32, but is not shown in FIG. 35.

White light emitted from the light source 315 is separated into three colored luminous fluxes (green light, blue light, and red light) through the dichroic mirrors 32 and 33. The separated colored luminous fluxes with the respective colors respectively pass through the polarization separating prisms 35a to 35c, are incident into and modulated through the reflective display elements 31a to 31c respectively corresponding to the ray with the respective colors, are subjected to color synthesis through the cross dichroic prism 34, and are subsequently incident into the imaging optical system 310. The imaging optical system 310 projects an optical image, which is based on the modulated light modulated through the reflective display elements 31a to 31c, onto a screen 305.

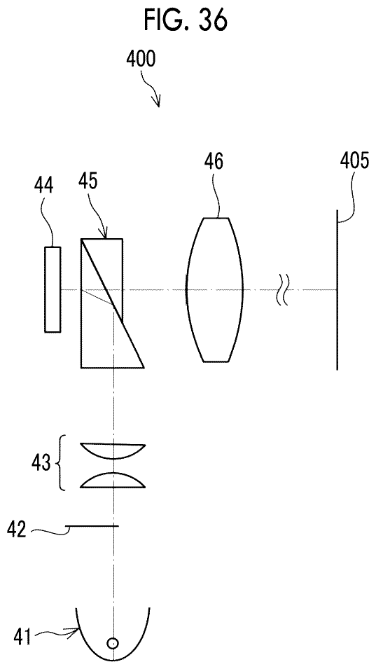

FIG. 36 is a schematic configuration diagram showing a projection type display device according to still another embodiment of the present disclosure. A projection type display device 400 shown in FIG. 36 includes an imaging optical system 46 according to the embodiment of the present disclosure, a light source 41, and a DMD element 44 as a light valve corresponding to each color light and outputting an optical image. Further, the projection type display device 400 includes a color wheel 42, a light guide optical system 43, and a TIR prism 45. In addition, FIG. 36 schematically shows the imaging optical system 46.

Filters having three colors of green, blue, and red are provided on a circumference of the color wheel 42. In a case where the color wheel 42 is rotated, the filters having the respective colors are sequentially inserted on the optical path. White light from the light source 41 is incident into the rotating color wheel 42 and is time-divided into colored luminous fluxes having three colors (green light, blue light, and red light). The colored luminous fluxes having the respective colors after the time-division pass through the light guide optical system 43 and the TIR prism 45, are incident into the DMD elements 44 to be modulated, and are incident into the imaging optical system 46 through the TIR prism 45 again. The imaging optical system 46 projects an optical image based on the modulated light modulated by the DMD element 44 onto a screen 405.

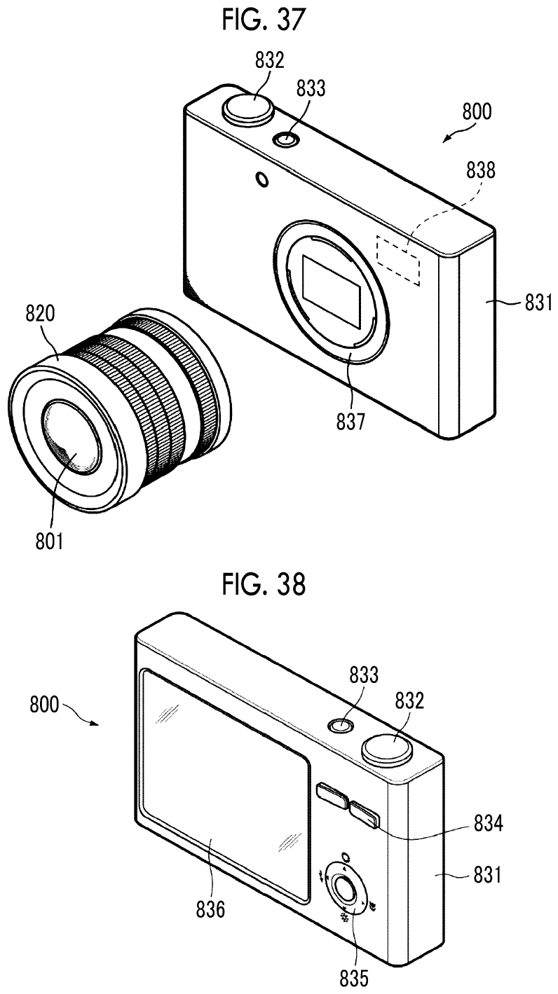

FIGS. 37 and 38 are external views showing a camera 800 that is an imaging apparatus according to an embodiment of the present disclosure. FIG. 37 is a perspective view showing the camera 800 in a view from the front side, and FIG. 38 is a perspective view showing the camera 800 in a view from the rear side. The camera 800 is a so-called mirrorless type digital camera, and an interchangeable lens 820 can be removably attached thereto. The interchangeable lens 820 is composed of an imaging optical system 801 according to an embodiment of the present disclosure accommodated in a lens barrel.

The camera 800 includes a camera body 831. A shutter button 832 and a power button 833 are provided on an upper surface of the camera body 831. Further, an operator 834, an operator 835 and a display unit 836 are provided on the rear surface of the camera body 831. The display unit 836 displays a captured image and an image within an angle of view before imaging.

An imaging aperture through which light from an imaging target is incident is provided at the center on the front surface of the camera body 831. A mount 837 is provided at a position corresponding to the imaging aperture. The interchangeable lens 820 is mounted on the camera body 831 with the mount 837 interposed therebetween.

An imaging element 838 is provided in the camera body 831. The imaging element 838 outputs an imaging signal corresponding to the subject image formed by the interchangeable lens 820. For example, a charge coupled device (CCD) or a complementary metal oxide semiconductor (CMOS) is used as the imaging element 838. A signal processing circuit (not shown), a recording medium (not shown), and the like are provided in the camera body 831. The signal processing circuit processes the imaging signal output from the imaging element 838 to generate an image. The recording medium is used to record the generated image. The camera 800 can capture a still image or a motion picture by pressing the shutter button 832, and records image data obtained through imaging in the recording medium.

The present disclosed technology has been hitherto described through embodiments and examples, but the technique of the present disclosure is not limited to the above-mentioned embodiments and examples, and may be modified into various forms. The curvature radius of each of the reflecting surfaces and the curvature radius, the surface spacing, the refractive index, the Abbe number, the aspherical coefficient of each of the lenses are not limited to the values shown in each of the examples, and may be other values.

In addition, the projection type display device according to the present disclosed technology is not limited to the above-described configuration. For example, various changes of aspects can be made for the optical members and the light valves used for the luminous flux separation or the luminous flux synthesis. The light valve is not limited to an aspect in which light emitted from the light source is spatially modulated by an image display element and is output as an optical image based on image data, but may be an aspect in which light itself output from a light emitting image display element is output as an optical image based on the image data. Examples of the light emitting image display element include an image display element where light emitting elements such as light emitting diodes (LED) or organic light emitting diodes (OLED) are two-dimensionally arranged.

Further, an imaging apparatus according to the present disclosed technology is not limited to the above-described configuration, and can be modified into various aspects such as a non-mirrorless type camera, a film camera, a video camera, a security camera, and a camera for movie imaging.

Regarding the above-described embodiments and examples, the following supplementary notes will be further disclosed.

### Supplementary Note 1

An imaging optical system consisting of a reflective optical system and a refractive optical system including a plurality of lenses along an optical path in order from an enlargement side to a reduction side,
in which the reflective optical system includes a first reflecting surface having a positive power, a second reflecting surface having a power, and a third reflecting surface having a positive power along the optical path in order from the enlargement side to the reduction side,
a first intermediate image is formed at a position conjugate to a reduction-side imaging plane on the optical path between the third reflecting surface and the refractive optical system,
a second intermediate image is formed at a position conjugate to the first intermediate image in the reflective optical system,
intermediate images formed closer to the enlargement side than the refractive optical system are only the first intermediate image and the second intermediate image, and
in a case where a maximum half angle of view of the enlargement side is represented by ω, Conditional Expression (1) represented by

$$4.6 < tan ω < 50 \qquad ( 1 )$$

is satisfied.

### Supplementary Note 2

The imaging optical system according to Supplementary Note 1,
in which in a case where a magnification of the imaging optical system is represented by β,
a distance on an optical axis from the first reflecting surface to an enlargement-side imaging plane is represented by DO, and
a distance on the optical axis from the first reflecting surface to the reduction-side imaging plane is represented by d, Conditional Expression (2) represented by

$$77.5 < \vert β \times d / D 0 \vert < 200 \qquad ( 2 )$$

is satisfied.

### Supplementary Note 3

The imaging optical system according to Supplementary Note 1 or 2,
in which in a case where a distance between an optical axis and a reflection point having a longest distance from the optical axis among reflection points of a ray on the first reflecting surface is represented by RM1,
a distance between the optical axis and a reflection point having a longest distance from the optical axis among reflection points of a ray on the second reflecting surface is represented by RM2,
a distance between the optical axis and a reflection point having a longest distance from the optical axis among reflection points of a ray on the third reflecting surface is represented by RM3, and
a maximum image height on the reduction-side imaging plane is represented by Y, Conditional Expression (3) represented by

$$10 < ( RM 1 + RM 2 + RM 3 ) / Y < 25 \qquad ( 3 )$$

is satisfied.

### Supplementary Note 4

The imaging optical system according to any one of Supplementary Notes 1 to 3, in which in a case where a distance between an optical axis and a reflection point having a longest distance from the optical axis among reflection points of a ray on the first reflecting surface is represented by RM1, and
a distance on the optical axis from the first reflecting surface to the reduction-side imaging plane is represented by d, Conditional Expression (4) represented by

$$0.1 < RM 3 / d < 0.4 \qquad ( 4 )$$

is satisfied.

### Supplementary Note 5

The imaging optical system according to any one of Supplementary Notes 1 to 4, in which in a case where a distance between an optical axis and a reflection point having a longest distance from the optical axis among reflection points of a ray on the third reflecting surface is represented by RM3, and
a distance on the optical axis from the first reflecting surface to the reduction-side imaging plane is represented by d, Conditional Expression (5) represented by

$$0.1 < RM 3 / d < 0.4 \qquad ( 5 )$$

is satisfied.

### Supplementary Note 6

The imaging optical system according to any one of Supplementary Notes 1 to 5,
in which the refractive optical system includes three or more negative lenses.

### Supplementary Note 7

The imaging optical system according to Supplementary Note 4,
in which the refractive optical system includes four or more negative lenses.

### Supplementary Note 8

The imaging optical system according to any one of Supplementary Notes 1 to 7,
in which the second intermediate image is formed on the optical path between the first reflecting surface and the second reflecting surface.

### Supplementary Note 9

The imaging optical system according to any one of Supplementary Notes 1 to 8,
in which in a case where a focal length of the first reflecting surface is represented by fM1, and
a focal length of the third reflecting surface is represented by fM3, Conditional Expression (6) represented by

$$0.25 < fM 1 / fM 4 < 4 \qquad ( 6 )$$

is satisfied.

### Supplementary Note 10

The imaging optical system according to any one of Supplementary Notes 1 to 9,
in which the first reflecting surface and the third reflecting surface are formed of the same member and have the same surface shape.

### Supplementary Note 11

The imaging optical system according to any one of Supplementary Notes 1 to 10,
in which in a case where a spacing on an optical axis between the first reflecting surface and the second reflecting surface is represented by dM1M2, and
a distance on the optical axis from the first reflecting surface to the reduction-side imaging plane is represented by d, Conditional Expression (7) represented by

$$0.2 < \vert dM 1 M 2 \vert / d < 0.5 \qquad ( 7 )$$

is satisfied.

### Supplementary Note 12

The imaging optical system according to any one of Supplementary Notes 1 to 11,
in which a lens closest to the reduction side in the refractive optical system has a positive power, and
in a case where an Abbe number of the lens closest to the reduction side in the refractive optical system with respect to a d line is represented by vp, Conditional Expression (8) represented by

$$40 < vp < 100 \qquad ( 8 )$$

is satisfied.

### Supplementary Note 13

The imaging optical system according to any one of Supplementary Notes 1 to 12,
in which a lens closest to the reduction side in the refractive optical system includes a lens surface having an aspherical shape.

### Supplementary Note 14

The imaging optical system according to any one of Supplementary Notes 1 to 13,
in which at least one of a lens closest to the enlargement side in the refractive optical system or a second lens from the enlargement side in the refractive optical system is a first negative lens having a negative power.

### Supplementary Note 15

The imaging optical system according to Supplementary Note 14,
in which the first negative lens includes a lens surface having an aspherical shape.

### Supplementary Note 16

The imaging optical system according to any one of Supplementary Notes 1 to 15,
in which the number of lenses in the refractive optical system is 6 or less.

### Supplementary Note 17

The imaging optical system according to any one of Supplementary Notes 1 to 15,
in which the number of lenses in the refractive optical system is 10 or more.

### Supplementary Note 18

A projection type display device comprising:
the imaging optical system according to any one of Supplementary Notes 1 to 17.

### Supplementary Note 19

An imaging apparatus comprising:
the imaging optical system according to any one of Supplementary Notes 1 to 17.

What is claimed is:

1. An imaging optical system consisting of a reflective optical system and a refractive optical system including a plurality of lenses along an optical path in order from an enlargement side to a reduction side,
wherein the reflective optical system includes a first reflecting surface having a positive power, a second reflecting surface having a power, and a third reflecting surface having a positive power along the optical path in order from the enlargement side to the reduction side,
a first intermediate image is formed at a position conjugate to a reduction-side imaging plane on the optical path between the third reflecting surface and the refractive optical system,
a second intermediate image is formed at a position conjugate to the first intermediate image in the reflective optical system,
intermediate images formed closer to the enlargement side than the refractive optical system are only the first intermediate image and the second intermediate image, and
in a case where a maximum half angle of view of the enlargement side is represented by ω, Conditional Expression (1) represented by
$$4.6 < tan ω < 50 \qquad ( 1 )$$
is satisfied.

2. The imaging optical system according to claim 1,
wherein in a case where a magnification of the imaging optical system is represented by β,
a distance on an optical axis from the first reflecting surface to an enlargement-side imaging plane is represented by DO, and
a distance on the optical axis from the first reflecting surface to the reduction-side imaging plane is represented by d, Conditional Expression (2) represented by
$$77.5 < \vert β \times d / D 0 \vert < 200 \qquad ( 2 )$$
is satisfied.

3. The imaging optical system according to claim 1,
wherein in a case where a distance between an optical axis and a reflection point having a longest distance from the optical axis among reflection points of a ray on the first reflecting surface is represented by RM1,
a distance between the optical axis and a reflection point having a longest distance from the optical axis among reflection points of a ray on the second reflecting surface is represented by RM2,
a distance between the optical axis and a reflection point having a longest distance from the optical axis among reflection points of a ray on the third reflecting surface is represented by RM3, and
a maximum image height on the reduction-side imaging plane is represented by Y, Conditional Expression (3) represented by
$$10 < ( RM 1 + RM 2 + RM 3 ) / Y < 25 \qquad ( 3 )$$
is satisfied.

4. The imaging optical system according to claim 1,
wherein in a case where a distance between an optical axis and a reflection point having a longest distance from the optical axis among reflection points of a ray on the first reflecting surface is represented by RM1, and
a distance on the optical axis from the first reflecting surface to the reduction-side imaging plane is represented by d, Conditional Expression (4) represented by
$$0 \text{.1} < RM 1 / d < 0.5 \qquad ( 4 )$$
is satisfied.

5. The imaging optical system according to claim 1,
wherein in a case where a distance between an optical axis and a reflection point having a longest distance from the optical axis among reflection points of a ray on the third reflecting surface is represented by RM3, and
a distance on the optical axis from the first reflecting surface to the reduction-side imaging plane is represented by d, Conditional Expression (5) represented by
$$0 \text{.1} < RM 3 / d < 0.4 \qquad ( 5 )$$
is satisfied.

6. The imaging optical system according to claim 1,
wherein the refractive optical system includes three or more negative lenses.

7. The imaging optical system according to claim 4,
wherein the refractive optical system includes four or more negative lenses.

8. The imaging optical system according to claim 1,
wherein the second intermediate image is formed on the optical path between the first reflecting surface and the second reflecting surface.

9. The imaging optical system according to claim 1,
wherein in a case where a focal length of the first reflecting surface is represented by fM1, and
a focal length of the third reflecting surface is represented by fM3, Conditional Expression (6) represented by
$$0.25 < fM 1 / fM 3 < 4 \qquad ( 6 )$$
is satisfied.

10. The imaging optical system according to claim 9,
wherein the first reflecting surface and the third reflecting surface are formed of the same member and have the same surface shape.

11. The imaging optical system according to claim 1,
wherein in a case where a spacing on an optical axis between the first reflecting surface and the second reflecting surface is represented by dM1M2, and
a distance on the optical axis from the first reflecting surface to the reduction-side imaging plane is represented by d, Conditional Expression (7) represented by
$$0.2 < \vert dM 1 M 2 \vert / d < 0.5 \qquad ( 7 )$$
is satisfied.

12. The imaging optical system according to claim 1,
wherein a lens closest to the reduction side in the refractive optical system has a positive power, and
in a case where an Abbe number of the lens closest to the reduction side in the refractive optical system with respect to a d line is represented by vp, Conditional Expression (8) represented by
$$40 < vp < 100 \qquad ( 8 )$$
is satisfied.

13. The imaging optical system according to claim 1,
wherein a lens closest to the reduction side in the refractive optical system includes a lens surface having an aspherical shape.

14. The imaging optical system according to claim 1,
wherein at least one of a lens closest to the enlargement side in the refractive optical system or a second lens from the enlargement side in the refractive optical system is a first negative lens having a negative power.

15. The imaging optical system according to claim 14,
wherein the first negative lens includes a lens surface having an aspherical shape.

16. The imaging optical system according to claim 1,
wherein the number of lenses in the refractive optical system is 6 or less.

17. The imaging optical system according to claim 1,
wherein the number of lenses in the refractive optical system is 10 or more.

18. A projection type display device comprising:
the imaging optical system according to claim 1.

19. An imaging apparatus comprising:
the imaging optical system according to claim 1.
